(19) United States
(12) Patent Application Publication
(10) Pub. No.: US 2024/0382962 A1
(43) Pub. Date: Nov. 21, 2024

(54) DROPLET INJECTOR FOR TIME-RESOLVED CRYSTALLOGRAPHY WITH XFELS

(71) Applicants: Alexandra Ros, Phoenix, AZ (US); Diandra Doppler, Scottsdale, AZ (US); Mukul Sonker, Tempe, AZ (US); Ana Egatz-Gomez, Phoenix, AZ (US); Richard Kirian, Tempe, AZ (US); Sahba Zaare, Mesa, AZ (US); Abhik Manna, Tempe, AZ (US); Konstantinos Karpos, Salt Lake City, UT (US); Roberto Alvarez, Phoenix, AZ (US)

(72) Inventors: Alexandra Ros, Phoenix, AZ (US); Diandra Doppler, Scottsdale, AZ (US); Mukul Sonker, Tempe, AZ (US); Ana Egatz-Gomez, Phoenix, AZ (US); Richard Kirian, Tempe, AZ (US); Sahba Zaare, Mesa, AZ (US); Abhik Manna, Tempe, AZ (US); Konstantinos Karpos, Salt Lake City, UT (US); Roberto Alvarez, Phoenix, AZ (US)

(21) Appl. No.: 18/665,475

(22) Filed: May 15, 2024

Related U.S. Application Data
(60) Provisional application No. 63/639,501, filed on Apr. 26, 2024.
(60) Provisional application No. 63/502,367, filed on May 15, 2023.

(51) Int. Cl. B01L 3/00; B01L 3/02

(52) U.S. Cl. CPC B01L 3/502784; B01L 3/0241; B01L 3/502715; B01L 2300/0861; B01L 2400/0487

(57) ABSTRACT

A microfluidic droplet injector (MDI) for serial femtosecond crystallography (SFX). The MDI includes a droplet generator, a droplet detector, and a nozzle. The droplet generator includes an oil channel configured to supply an oil solution at a first flow rate, a substrate channel configured to supply a substrate solution at a second flow rate, a crystal channel configured to supply a crystal solution at the second flow rate, a first intersection point of the substrate channel and the crystal channel to form a sample channel configured to supply a sample solution, the droplet generator configured to mix the substrate solution and the crystal solution at the first intersection point to initiate a reaction between the substrate solution and the crystal solution in the sample solution, the reaction including a first delay based on the second flow rate, and a second intersection point of the oil channel and the sample channel, the droplet generator configured to generate a segmented droplet of the sample solution surrounded by the oil solution at the second intersection point based on the first flow rate and the second flow rate. The droplet detector is configured to receive the segmented droplet of the sample solution surrounded by the oil solution from the droplet generator and detect a presence of the segmented droplet. The nozzle is configured to receive the segmented droplet of the sample solution surrounded by the oil solution from the droplet generator and jet the segmented droplet of the sample solution surrounded by the oil solution from the MDI for SFX, such that SFX occurs on the segmented droplet including the reaction at the first delay.

### CROSS-REFERENCE TO RELATED APPLICATIONS

This application is a non-provisional of and claims the benefit of U.S. Provisional Application No. 63/502,367, filed on May 15, 2023, and U.S. Provisional Application No. 63/639,501, filed on Apr. 26, 2024, the entire contents of each of which are incorporated herein by reference.

### TECHNICAL FIELD

The present disclosure is directed to microfluidic injectors for structural biology techniques.

### BACKGROUND

With nearly 205,000 structures deposited in the protein data bank (PDB) as of April 2023, protein X-ray crystallography has become one of the most successful structural biology techniques since the first three-dimensional structure of a protein, myoglobin, was revealed. For example, insulin's mechanism of action, mass production of penicillin, understanding sickle cell anemia, the structure of DNA, and HIV inhibitors, are just a few of the many discoveries made possible by X-ray crystallography. Previous advancements in crystallography were enabled through technological improvements in sample handling such as, for example, the use of cryoprotectant mother liquors to mitigate radiation damage and produce macromolecular structures at sub-zero temperature, and sealed crystal holders, oils, and humidified environments to slow down dehydration and prolong measurement times. The development of bright X-ray radiation sources such as third generation synchrotrons and hard X-ray Free Electron Lasers (XFELs) has made it possible to determine structures of very weakly-diffracting biomacromolecular crystals at room temperature. These two X-ray sources are, however, characterized by significant differences in pulse duration, peak brilliance, and repetition structure and therefore require the development of different approaches to sample handling.

With the increased availability of XFELs over the past 10 years, serial femtosecond crystallography (SFX) methods have been developed to obtain room-temperature structural information from crystals that are too small, weakly scattering, or radiation damage-sensitive to be probed at synchrotrons. In SFX, each crystal is typically exposed to a radiation source only once because the intense, ultrashort XFEL pulse triggers a cascade of ionization events that ends with the crystal exploding. However, when atomic motions of protein molecules inside crystals are slower than the duration of an XFEL pulse, diffraction patterns can be recorded on a detector before structure-altering radiation damage becomes apparent. Since each diffraction pattern only measures partial Bragg reflection intensities at a single random orientation, a few thousands of crystals are needed to collect a complete data set.

Sample consumption for SFX with XFELs remains a major limitation preventing broader use of this technology in macromolecular crystallography. This drawback is exacerbated in the case of time-resolved (TR)-SFX experiments, where the amount of sample required per reaction time point is multiplied by the number of time points investigated.

Accordingly, a device that minimizes the amount of sample needed while allowing for precise reaction dynamics of protein interactions to be measured is desirable.

### SUMMARY

Droplet injection strategies are a promising tool to reduce the large amount of sample consumed in serial femtosecond crystallography (SFX) measurements at X-ray free electron lasers (XFELs) with continuous injection approaches.

The present disclosure provides a modular microfluidic droplet injector (MDI) according to an embodiment. In one embodiment, the MDI is a fully 3D-printed droplet injector with a reduced footprint for SFX at the MEX instrument at LCLS. In an example described below, the MDI was successfully applied to deliver microcrystals of the human NAD(P)H: Quinone oxidoreductase 1 (NQO1) and phycocyanin. The droplet generation conditions through electrical stimulation were investigated for both protein samples and hardware and software components were implemented for optimized crystal injection at the Macromolecular Femtosecond Crystallography (MFX) instrument at the Stanford Linac Coherent Light Source (LCLS). Under optimized droplet injection conditions, it was demonstrated that up to a 4-fold sample consumption savings can be achieved with the droplet injector.

In addition, a full data set was collected with droplet injection for NQO1 protein crystals with a resolution up to 2.7 Å. This has led to the first room-temperature structure of NQO1 at an XFEL. NQO1 is a flavoenzyme associated with cancer, Alzheimer's and Parkinson's disease, making it an attractive target for drug discovery. The results from the examples described below reveal that residues Tyr128 and Phe232, which play key roles in the function of the protein, show an unexpected conformational heterogeneity at room temperature within the crystals. These results suggest that different substrates exist in the conformational ensemble of NQO1 with functional and mechanistic implications for the enzyme's negative cooperativity through a conformational selection mechanism. Thus, the examples described below using the MDI demonstrates that microfluidic droplet injection constitutes a robust sample-conserving injection method for SFX studies on protein crystals that are difficult to obtain in amounts necessary for continuous injection, including the large sample quantities required for time-resolved mix-and-inject studies.

Thus, the examples described below, in order to reduce the limitation of sample consumption, may implement segmented droplet generation in conjunction with a mix-and-inject approach for TR studies on NAD(P)H:quinone oxidoreductase 1 (NQO1). The design and application of mix-and-inject segmented droplet injectors were implemented for the Single Particles, Clusters, and Biomolecules & Serial Femtosecond Crystallography (SPB/SFX) instrument at the European XFEL (EuXFEL) with a synchronized droplet injection approach that includes liquid phase protein crystal injection. In the examples described below, TR-crystallography experiments with this approach can be implemented for a 305 ms and a 1190 ms time point in the reaction of NQO1 with its coenzyme NADH. In some examples, up to 97% of the sample is conserved compared to continuous crystal suspension injection with a gas dynamic virtual nozzle. Furthermore, obtained structural information for the reaction of NQO1 with NADH may be part of future elucidation of the reaction mechanism of therapeutic enzymes.

Serial crystallography, both at XFELs and synchrotrons, is a robust tool for protein structural analysis. For example, serial crystallography may exceed limitations in traditional goniometer-based crystallography approaches requiring large crystals where X-ray damage can be prohibitive and cryogenic approaches remain imperative. Similarly, crystal defects become problematic in larger crystals required for traditional crystallography approaches, whereas in SFX with XFELs, such effects remain suppressed as crystals in the order of 1-20 micrometers (μm) are typically employed.

Furthermore, serial crystallography introduces dynamic studies on proteins both for light-induced reactions and reactions induced through a substrate or binding partner. To facilitate the latter approach termed mix-and-inject serial crystallography (MISC), small crystals are mixed with a substrate or binding partner on time scales of milliseconds to initiate the reaction and then be probed by the X-ray beam at a time delay representing the time along a reaction coordinate. Time-resolved experiments with MISC are implemented to study enzymatic reactions occurring from milliseconds up to seconds. Some examples, among many, of the dynamic SFX technique include the reaction of the β-lactamase C (BlaC) from Mycobacterium tuberculosis with an antibiotic ceftriaxone and an inhibitor sulbactam, the reaction of a riboswitch RNA with the substrate adenine, the cytochrome C oxidase with O₂ and the isocyanide hydratase (ICH) enzyme, which catalyzes the hydration of isocyanides.

A bottleneck in MISC that remains is the large amount of sample required to probe enough snapshots of each reaction time point to obtain suitable information about the reaction mechanism. For every time point tested, an amount of consumed sample increases to the extent necessary to obtain a complete data set. In other words, if approximately 100 milligrams (mg) of protein is typically required to determine a static structure using jets as sample delivery, the protein amount is multiplied by every time point desired in a TR experiment with MISC. Such quantities are often prohibiting TR-SFX with the MISC approach, as proteins may not be available in such large abundance. Therefore, past efforts in the improvement of serial crystallography techniques have targeted sample injection and delivery approaches that allow a significant reduction in the amount of sample needed for a full data set.

Several previous approaches that reduce the amount of sample required for an SFX experiment have been described. One of these previous approaches is a fixed-target approach in which a crystal slurry loaded onto a thin support to minimize background, is scanned in front of the X-ray beam. The fixed-target approach typically includes only a few microliters (<1 mg of protein) of a crystal slurry to fill a chip from which a complete data set can be obtained. However, fixed-target devices may suffer from poor vacuum compatibility inducing dehydration, specifically when crystals are loaded between very thin support layers to reduce background or on non-enclosed devices to facilitate loading through wicking. Additionally, fixed target devices are limited in the speed at which the chip can raster in front of the X-ray source, therefore they are compatible with lower repetition rates. More importantly, since crystals are typically placed in an enclosed environment, fixed-target devices are impractical for TR-SFX experiments that require substrate mixing.

To sustain the advantages of established jet-based injection techniques, two main previous approaches that facilitate the reduction of sample consumption have been developed. The first approach are viscous injectors which inject crystal samples in a highly-viscous stream, extruding samples at flow rates ranging from a few nanoliters per minute (nL/min) up to only a few microliters per minute (μL/min). Originally developed for SFX experiments with membrane protein crystals grown in lipidic cubic phase, viscous injectors were tested to inject soluble protein crystals with a variety of viscous media both at XFELs and synchrotron radiation sources. An advantage of the viscous jets is that they can be coupled with a laser source to perform TR experiments for light-sensitive proteins, however, they are also limited in the speed of extrusion and are therefore only lower repetition rate compatible. The second jet-based approach relates to the formation of droplets, ejecting them at a desired frequency to intersect with the X-ray beam. Free-standing droplets can be generated from nozzles with piezoelectric or acoustic actuation. The droplets generated are in the range of picoliters to nanoliters (pL to nL), significantly reducing sample requirements. However, injection into a vacuum remains challenging, and clogging effects may hamper crystallography for samples injected in droplets.

Another example of droplet generators divides sample-laden droplets within an immiscible oil stream. These droplet techniques implement in situ droplet crystallization before X-ray diffraction but also enable crystal-containing droplets to mix with a substrate through droplet coalescence post-crystal formation, thereby enabling time-resolved diffraction experiments. Moreover, these droplet generators are applicable for certain light-induced time-resolved studies and experiments including crystal injection into a low background environment (e.g., a vacuum). Droplet generators including the oil stream may be useful when crystals cannot grow to an appropriate size and quality required in viscous injection media or when other experimental parameters hinder the use of fixed-target approaches. Additionally, these techniques are particularly suited for experiments where liquid injection with a gas dynamic virtual nozzle (GDVN) is used. An advantage of segmented flow droplet injection may be that principles of continuous injection with a GDVN are directly applied, such as established crystallization parameters (e.g., maintaining growth media and established crystal size), but also the characteristics of the created jet (such as jet velocity and jet thickness). Additionally, with small modifications, these devices can generate droplets that are compatible with both high and low-repetition rate XFELs. GDVN injection is a robust technique that has contributed to approximately 30% of the structures added to the Protein Data Bank (PDB) using reported serial femtosecond crystallography experiments, thus investigating further development is imperative for propelling forward time-resolved structural biology, opening doors to unprecedented insights into dynamic molecular processes.

In some instances, SFX with the segmented droplet generation approach was implemented for several proteins so far, both at the Macromolecular Crystallography Instrument (MFX) at the Linac Coherent Light Source (LCLS) at SLAC National Accelerator Laboratory, and the European XFEL (EuXFEL), with sample savings of approximately 75% and 60%. However, a time-resolved crystallography experiment with segmented droplet injection has not been demonstrated to date. As described in some examples below, the segmented droplet approach may reduce sample consumption by a factor of 100 at the EuXFEL when droplets of the size spanning an entire pulse train are created at 10 Hz. Segmented droplet injection would thus be ideally suited for time-resolved experiments based on the mix-and-inject principle at the EuXFEL.

In some instances, devices described herein determine the room-temperature structure of NQO1 in complex with NADH using serial synchrotron crystallography in combination with molecular dynamics simulations. Although relevant information is discovered on NQO1 dynamics and mechanism, the solved structure is a static picture of the reaction with NADH. Thus, to fully unravel the NQO1 function, exploration beyond static structures may be required. In examples described below, devices described herein conduct TR-SFX experiments on the NQO1 enzyme with its coenzyme NADH at the EuXFEL. In some instances, two time points are investigated, 300 and 1190 ms, using a mix-and-inject segmented droplet injector. The previously established segmented droplet injection principle was extended to include a mixer element just upstream of a droplet generation region in one completely 3D-printed device. The SPB/SFX experimental chamber at the EuXFEL is integrated with the mix-and-inject segmented droplet injector and applied the mixer/droplet injector to TR-SFX with NQO1. Particular focus is on the conditions of optimized synchronization of the droplets with the XFEL pulse trains and the characterization of reaction time points, and mixing times of this approach.

In one aspect, the disclosure provides a microfluidic droplet injector (MDI) for serial femtosecond crystallography (SFX) including a droplet generator having an oil channel supplying an oil solution at a first flow rate, a substrate channel supplying a substrate solution at a second flow rate, a crystal channel supplying a crystal solution at the second flow rate, a first intersection point of the substrate channel and the crystal channel to form a sample channel supplying a sample solution, the droplet generator mixes the substrate solution and the crystal solution at the first intersection point to initiate a reaction between the substrate solution and the crystal solution in the sample solution, the reaction including a first delay based on the second flow rate, and a second intersection point of the oil channel and the sample channel. The droplet generator generates a segmented droplet of the sample solution surrounded by the oil solution at the second intersection point based on the first flow rate and the second flow rate. The MDI also includes a droplet detector connected to the droplet generator. The droplet detector receives the segmented droplet of the sample solution surrounded by the oil solution from the droplet generator and detects a presence of the segmented droplet. The MDI also includes a nozzle connected to the droplet detector. The nozzle receives the segmented droplet of the sample solution surrounded by the oil solution from the droplet generator and jets the segmented droplet of the sample solution surrounded by the oil solution from the MDI for SFX, such that SFX occurs on the segmented droplet including the reaction at the first delay.

In some aspects, the nozzle is a gas dynamic virtual nozzle.

In some aspects, the nozzle jets the segmented droplet of the sample solution surrounded by the oil solution into an X-ray Free Electron Laser (XFEL) pulse for SFX.

In some aspects, the droplet generator generates the segmented droplet of the sample solution surrounded by the oil solution based on a frequency of the XFEL pulse.

In some aspects, an optimized size and configuration of the droplet generator, the droplet detector, and the nozzle use a 4-fold reduction in volume of the sample solution for output through the nozzle.

In some aspects, the sample solution includes protein crystals.

In some aspects, the protein crystals are human NAD(P)H: Quinone oxidoreductase 1 (NQO1).

In some aspects, the protein crystals are phycocyanin.

In another aspect, the disclosure provides, a microfluidic droplet injector (MDI) system including a microfluidic droplet injector (MDI) having a droplet generator. The droplet generator includes an oil channel supplying an oil solution at a first flow rate, a substrate channel supplying a substrate solution at a second flow rate, a crystal channel supplying a crystal solution at the second flow rate, a first intersection point of the substrate channel and the crystal channel to form a sample channel supplying a sample solution, the droplet generator mixes the substrate solution and the crystal solution at the first intersection point to initiate a reaction between the substrate solution and the crystal solution in the sample solution, the reaction including a first delay based on the second flow rate, and a second intersection point of the oil channel and the sample channel. The droplet generator generates a segmented droplet of the sample solution surrounded by the oil solution at the second intersection point based on the first flow rate and the second flow rate. The MDI also includes a droplet detector connected to the droplet generator. The droplet detector receives the segmented droplet of the sample solution surrounded by the oil solution from the droplet generator and detects a presence of the segmented droplet. The MDI also includes a nozzle connected to the droplet detector. The nozzle receives the segmented droplet of the sample solution surrounded by the oil solution from the droplet generator and jets the segmented droplet of the sample solution surrounded by the oil solution from the MDI for SFX, such that SFX occurs on the segmented droplet including the reaction at the first delay.

In some aspects, the nozzle is a gas dynamic virtual nozzle.

In some aspects, the nozzle jets the segmented droplet of the sample solution surrounded by the oil solution into an X-ray Free Electron Laser (XFEL) pulse for SFX.

In some aspects, the droplet generator generates the segmented droplet of the sample solution surrounded by the oil solution based on a frequency of the XFEL pulse.

In some aspects, an optimized size and configuration of the droplet generator, the droplet detector, and the nozzle use a 4-fold reduction in volume of the sample solution for output through the nozzle.

In some aspects, the sample solution includes protein crystals.

In some aspects, the protein crystals are human NAD(P)H: Quinone oxidoreductase 1 (NQO1).

In some aspects, the protein crystals are phycocyanin.

In another aspect, the disclosure provides a droplet generator for a microfluidic droplet injector (MDI), including an oil channel supplying an oil solution at a first flow rate, a substrate channel supplying a substrate solution at a second flow rate, a crystal channel supplying a crystal solution at the second flow rate, a first intersection point of the substrate channel and the crystal channel to form a sample channel supplying a sample solution, the droplet generator mixes the substrate solution and the crystal solution at the first intersection point to initiate a reaction between the substrate solution and the crystal solution in the sample solution, the reaction including a first delay based on the second flow rate, and a second intersection point of the oil channel and the sample channel. The droplet generator generates a segmented droplet of the sample solution surrounded by the oil solution at the second intersection point based on the first flow rate and the second flow rate and the segmented droplet having the reaction at the first delay.

In some aspects, the droplet generator generates a continuous stream including a plurality of segmented droplets.

In some aspects, each of the plurality of segmented droplets is surrounded by the oil solution in the continuous stream.

In some aspects, the sample solution comprises protein crystals.

Other aspects of the disclosure will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a schematic set-up of a microfluidic droplet injector (MDI) and control hardware implemented at a macromolecular femtosecond crystallography (MFX) instrument, according to some embodiments.

FIG. 2 illustrates a graph showing droplet detector voltage outputs for a plurality of droplets from an MDI, according to some embodiments.

FIG. 3 illustrates a characteristic waterfall plot for continuously triggered and locked-in droplets at 120 Hz at the MEX instrument, according to some embodiments.

FIG. 4 illustrates a graph showing examples for parameter sweeps to diagnose droplet injection conditions, according to some embodiments.

FIG. 5 illustrates a graph showing implementation of a parameter sweep for NQO1 with variation of phase delay (Øs), according to some embodiments.

FIG. 6 is an image illustrating a serial femtosecond crystallography (SFX) structure of human NQO1 from an MFX instrument, according to some embodiments.

FIG. 7 is an image illustrating superimposition of monomers found in an asymmetric unit of the NQO1 structure from an MFX instrument, according to some embodiments.

FIG. 8 illustrates an MDI implemented with an MFX instrument, according to some embodiments.

FIG. 9 illustrates the MDI implemented with the MFX instrument of FIG. 8, according to some embodiments.

FIG. 10 is an image illustrating a room temperature X-ray Free Electron Laser (XFEL) NQO1 structure from an MDI, according to some embodiments.

FIG. 11 illustrates an integrated mixer and nozzle of an MDI, according to some embodiments.

FIG. 12 illustrates an integrated mixer and nozzle of an MDI, according to some embodiments.

FIG. 13 illustrates an MDI for a Single Particles, Clusters, and Biomolecules & Serial Femtosecond Crystallography (SPB/SFX) instrument, according to some embodiments.

FIG. 14 is an image illustrating time-resolved SFX of an NQO1 structure with an MDI, according to some embodiments.

FIG. 15 illustrates an MDI setup with control hardware and X-ray interaction region in an SPB/SFX instrument, according to some embodiments.

FIG. 16 is an image illustrating channels of an MDI setup and corresponding waterfall plots, according to some embodiments.

FIG. 17 is an image illustrating a crystal droplet from an MDI and a corresponding waterfall plot, according to some embodiments.

FIG. 18 is an image illustrating a representative diffraction pattern of an NQO1-NADH structure for a 1190 ms time point using an MDI, according to some embodiments.

FIG. 19 illustrates a contact angle characterization for a boundary created between oil, water, and 3D-printed substrate using an MDI, according to some embodiments.

FIG. 20 illustrates a graph showing a waterfall plot collected during droplet delivery of mixed NQO1 crystals with an MDI, according to some embodiments.

FIG. 21 illustrates a schematic representation of an MDI divided into partitions and corresponding droplet computational models, according to some embodiments.

FIG. 22 illustrates a graph showing a numerical simulation for diffusion of substrate molecules in solution across channel width of an MDI, according to some embodiments.

FIG. 23 illustrates a graph showing a concentration of substrate along where a sample and oil streams meet within an MDI, according to some embodiments.

FIG. 24 is an image illustrating time-resolved structures of NQO1 with NADH at 305 and 1190 ms using an MDI, according to some embodiments.

FIG. 25 is an image illustrating structural comparison of free NQO1 structures, according to some embodiments.

FIG. 26 illustrates a structural comparison of catalytic sites and 2D channel dimensions for convection-diffusion simulation with an MDI, according to some embodiments.

FIG. 27 illustrates an MDI implemented with an MFX instrument, according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In some embodiments, XFELs generate femtosecond pulses at repetition rates between a range of 60 Hz to 4.5 MHz. Pulse repetition structures can be complex; for example, the European XFEL (EuXFEL) generates 10 X-ray pulse trains per second, with each train including as many as 352 pulses spaced approximately 900 ns apart. An example of a simpler pulse structure is an evenly spaced 120 pulse per second train at the Linac Coherent Light Source (LCLS) XFEL, which may be increased up to 1 MHz for LCLS-II. A drawback of SFX experiments at XFELs is the large amount of sample required in most instances. It can often take from months to years to produce protein crystals for SFX experiments, and the resulting protein crystals are often more precious than diamonds. Thus, the choice of sample delivery method may be important for conducting SFX experiments. In one example, a sample delivery method: 1) replenishes crystals in a sample interaction region at the same rate of XFEL pulses; 2) considers sample characteristics such as crystal size and morphology, fragility, and concentration; and 3) fulfills seemingly incompatible requisites, such as working in vacuum to avoid background scatter from air and preventing the sample from drying, freezing, or clogging.

A plurality of metrics is considered for implementation of sample injection systems. In some embodiments, the “hit rate” and “delivery efficiency” of a sample injection system are considered when implementing the sample injection system. The hit rate may be defined as a fraction of XFEL pulses that produce a useful diffraction pattern (e.g., one with Bragg reflections). The delivery efficiency may be defined as the number of useful diffraction patterns generated per sample quantity (e.g., hits per μL of solution for known protein concentrations or crystal density). As such, delivery efficiency is dependent on hit rate, and one may additionally define the “geometric efficiency” as a fraction of a sample volume that is exposed to X-rays from the XFEL pulses. In some embodiments, an injector has a geometric efficiency close to 1, a sample hit rate that depends on the stability of the injection set-up and sample quality (also close to 1), and a delivery efficiency that additionally depends on crystal size and density (for example, the delivery efficiency may exceed 1 to account for multiple crystals interacting with an X-ray beam in a single shot). However, a number of complications exist with respect to sample injections systems, such as the effect of sample exchange on hit rate, the effect of sample-loading dead volumes on delivery efficiency, and the effects of gas or liquid background signals on the ultimate signal-to-noise ratio of the measurement.

In some embodiments, sample delivery methods roughly fall into three categories: injection methods, fixed-target methods, and hybrid combinations of injection methods and fixed-target methods. Sample delivery methods based on injection deliver a thin stream of a crystal slurry that intersects the XFEL beam in either vacuum or helium and air atmospheres, typically using a gas dynamic virtual nozzle (GDVN). However, a drawback of jet injection is that most crystals are never hit by the X-rays, with most of the sample wasted in between pulses, so that a complete dataset may include up to several hundred milligrams of crystallized protein. The amount of sample wasted is multiplied with each time point measured in mix-and-inject time-resolved (TR) crystallography experiments, where each time point includes the same amount of protein crystals to obtain a full data set.

Double flow focusing nozzles (DFFN) and co-flow of oil and aqueous sample injection reduce sample consumption, stabilize sample flow, and reduce evaporative cooling in vacuum. In addition, viscous media injectors create low flow rates and reduce sample consumption, though viscous media injectors are not fast enough to replenish crystals at MHz repetition rate XFELs. Low flow rates for sample conservation during continuous liquid injection are induced using an electrospinning principle with a MESH injector at the expense of higher background when crystal slurries are probed in an electro-spun cone instead of the jet due to experimental optimizations of hit rates and potential impact on crystal structures.

In fixed-target methods, the crystal suspension is loaded onto the surface of a solid support that is rastered through the interaction region of the X-ray beam. Fixed-target devices use thin layers of materials such as, for example, silicon, cycloolefin-copolymer (COC), polydimethylsiloxane (PDMS), COC/PDMS combinations, polyethylene terephthalate, graphene layers in combination with polymers, and polyimide. Typically, fixed-target devices have high hit rates (e.g., 10-40%) compared to the lower hit rates (e.g., 1-10%) with continuous liquid delivery systems. However, despite the high sample hit rate, fixed-target devices usually include the use of more than one device for a complete data set and time-intensive procedures to load each device and/or exchange with the previous one (particularly for data collection in vacuum) during beamtimes. Evaporation during data collection may be problematic, and MHz repetition frequencies can hardly be realized. Fixed-target methods also affect data processing when the devices cause non-uniform and/or systematically varying background due to misalignment with ‘windows’ of the target, and residual salt traces from sample loading can result in additional diffraction spots.

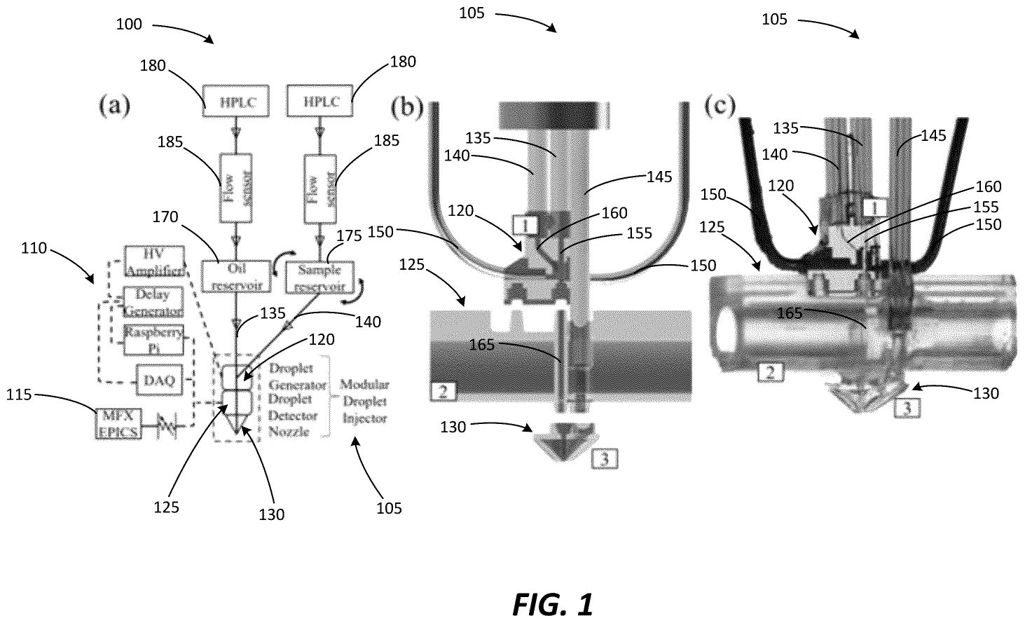

Droplet-based injection methods may address the unmet needs of lowering sample consumption with liquid crystal injectors. Droplet-based injection methods generate aqueous sample droplets via piezoelectric or acoustic effects referred to as droplet-on-demand techniques. Droplet-based injections methods generate droplets to match pulse structures of current XFELs. However, drop-on-demand techniques may be limited by clogging effects through settling crystals and may be incompatible with vacuum conditions. As described in embodiments herein, to overcome these limitations, segmented droplet generation generates crystal laden droplets through sheering at a microfluidic intersection segmented by an immiscible oil. Droplet injection for SFX experiments includes solving a first room-temperature structure of a 3-deoxy-D-manno-octulosonate 8-phosphate synthase (KDO8PS) protein at the EuXFEL. Solution of the KDO8PS protein includes matching a 120 Hz repetition rate of the LCLS with a capillary-coupled version of the droplet injector. As described in embodiments herein, a fully 3D-printed modular droplet injector (MDI) (for example, FIG. 1) integrates the injector components, but with a reduced footprint (e.g., about an order of magnitude in injector length) to case the use of the MDI in various XFEL experimental chambers. In addition, the MDI droplet injection is integrated with electrical triggering feedback control into a data stream at the MEX instrument at LCLS. Integrating the MDI droplet injection with the electrical triggering feedback control includes on-the-fly optimization of droplet injection parameters to maximize crystal hit rates.

### Example

MDI may be used for the proteins phycocyanin and the human NQO1 (NAP (P) H: quinone oxidoreductase 1). In some embodiments, the MDI reduces sample consumption by a factor of three to four and for the latter, determines the first room-temperature SFX structure at 2.7 Å resolution. NQO1 is a flavoenzyme essential for an antioxidant defense system, stabilization of tumor suppressors, and the NAD (P) H-dependent two-electron reduction of a plurality of substrates, including the activation of quinone-based chemotherapeutics. In addition, alterations in NQO1 function may be associated with cancer, Alzheimer's and Parkinson's disease, which makes NQO1 an attractive target for drug discovery. Embodiments described herein illustrate important insight into conformational heterogeneity of the human NQO1, highlighting high plasticity of NQO1 in a catalytic site and hence, shed light on the molecular basis of NQO1 functional cooperativity.

### Materials

Embodiments described herein may include the use of Perfluorodecalin (PFD) and 1H,1H,2H,2H-perfluoro-1-octanol (perfluorooctanol, PFO) (e.g., from Sigma-Aldrich, USA). Embodiments described herein may include the use of SU-8 developer (e.g., from Microchem, USA). Embodiments described herein may include the use of deionized water (18 MΩ) (e.g., from a LA755 Elga purification system (Elga Lab water, USA)), isopropyl alcohol (IPA), and ethanol (e.g., from VWR Analytical (USA) and Decon Labs (USA), respectively). Embodiments described herein may include the use of fused silica capillaries (e.g., about 360 μm outer diameter, 100 μm inner diameter from Molex, USA). Embodiments described herein may include the use of Hardman extra-fast setting epoxy (e.g., from All-Spec, USA). Embodiments described herein may include the use of conducting silver epoxy (e.g., from M.G. Chemicals Ltd., Canada), and insulated copper wire (e.g., from Remington Industries, USA). Embodiments described herein may include the use of E. coli BL21 (DE3) competent cells (e.g., from Agilent technologies (USA)). Embodiments described herein may include the use of yeast extract and tryptone (e.g., from Condalab (Madrid, Spain)). Embodiments described herein may include the use of EDTA-free Protease Inhibitor Cocktail, isopropyl β-D-1-thiogalactopyranoside (IPTG), ampicillin, sodium phosphate, sodium chloride, imidazole, flavin adenine dinucleotide (FAD), sodium acetate, K-HEPES, and Tris-HCl (e.g., from Merck (Madrid, Spain)). Embodiments described herein may include the use of Polyethylene glycol (PEG) 3350 (e.g., from Hampton Research (USA)).

### Modular Droplet Injector Design and Fabrication

As described in embodiments herein, MDI devices may be designed in Fusion 360 (AutoDesk, USA) or AutoCAD (AutoDesk, USA), 3D-printed with a Photonic Professional GT 3D-printer (Nanoscribe GmbH, Germany) using IP-S photoresist (Nanoscribe GmbH, Germany), developed in SU-8 developer, and rinsed in IPA.

FIG. 1 illustrates a schematic set-up of a microfluidic droplet injector (MDI) system 100, including a microfluidic droplet injector (MDI) 105, and control hardware 110 implemented at a macromolecular femtosecond crystallography (MFX) instrument 115, according to some embodiments. FIG. 1 also illustrates components of the MDI 105. In the illustrated embodiment of FIG. 1, the MDI 105 includes a droplet generator 120, a droplet detector 125 mechanically and fluidly connected to the droplet generator 120, and a GDVN (e.g., a nozzle) 130 mechanically and fluidly connected to the droplet detector 125. In some embodiments, the nozzle 130 is 3-D printed. The MDI 105 includes a plurality of capillaries to deliver solutions to the droplet generator 120. In the illustrated embodiment of FIG. 1, the MDI 105 includes an oil capillary 135, a sample capillary 140, and a sheathing gas capillary 145. The oil capillary 135 is mechanically and fluidly connected to the droplet generator 120 and delivers an oil solution to the droplet generator 120. The sample capillary 140 is mechanically and fluidly connected to the droplet generator 120. The sample capillary 140 delivers a sample (e.g., a protein crystal solution) to the droplet generator 120. As described in greater detail below, the droplet generator 120 mixes the sample and the oil solution to generate a droplet of the sample surrounded by the oil solution. The sheathing gas capillary 145 is mechanically and fluidly connected to the nozzle 130. The sheathing gas capillary 145 delivers a sheathing gas to the nozzle 130. In some embodiments, during ejection of a mixed oil and sample solution from the nozzle, the sheathing gas from the sheathing gas capillary 130 may reduce temperature, increase ejection, and reduce sample build-up at the nozzle 130. The MDI 105 also includes a plurality of electrode wires 150. The plurality of electrode wires 150 are connected to the droplet generator 120 and transmit electrical droplet stimulation to droplets within the droplet generator 120. In some embodiments, the plurality of electrode wires 150 include a nickel-chromium (NiCr) alloy composition.

In some embodiments, corresponding studs and receptacles on a top and/or a bottom of the droplet generator 120, the droplet detector 125, and the nozzle 130 to connect the droplet generator 120, the droplet detector 125, and the nozzle 130 to one another. The droplet generator 120 generates droplets at an intersection of an oil channel 155 and a sample channel 160. In some embodiments, the oil channel 155 and the sample channel 160 each include a cross-section of 100 μm×100 μm. In some embodiments, the intersection is a 45° intersection. In some embodiments, the oil channel 155 receives the oil solution from the oil capillary 135 within the droplet generator 120. In other embodiments, the oil channel 155 is a central channel of the oil capillary 135 that traverses the entirety of the oil capillary 135 to deliver the oil solution to the intersection. In some embodiments, the sample channel 160 receives the sample solution from the sample capillary 140 within the droplet generator 120. In other embodiments, the sample channel 160 is a central channel of the sample capillary 140 that traverses the entirety of the sample capillary 140 to deliver the sample solution to the intersection. In some embodiments, the MDI 105 includes electrode channels parallel to the oil channel 155, separated from the intersection by a distance (e.g., 5 μm) and filled with conducting silver epoxy-filled electrodes. In some embodiments, the electrode channels include two electrode channels. In some embodiments, the electrode channels include a volume of 350 μm×100 μm×50 μm. In some embodiments, each electrode is connected via the plurality of electrode wires 150 inserted in the droplet generator 120 and soldered to a wire insulated with enamel with the connection sealed with heat-shrink tubing. In some embodiments, the insulated wire is a 2 meter (m) copper wire. The droplet detector 125 is an optical fiber detector holder, with a droplet channel 165 for segmented liquid flow (e.g., a liquid flow including a combination of oil and sample) and axial openings to fit and align the tips of optical fiber cables. The sheathing gas capillary 145 wraps around the droplet detector 125 to connecting to the nozzle 130.

In some embodiments, the oil capillary 135, the sample capillary 140, and the sheathing gas capillary 145 are each inserted into the droplet generator 120 and the nozzle 130 (e.g., via a detector holder gas line inlet), respectively, and mechanically connected with epoxy. After the capillaries are cured in place, the droplet generator 120, the droplet detector 125, and the nozzle 130 are mechanically connected together by plugging in the studs and receptacles and applying the epoxy.

### Fluidic Operation and Setup

In some embodiments, the MDI 105 includes an oil reservoir 170 and a sample reservoir 175. Oil and a crystal sample are housed in the oil reservoir 170 and the sample reservoir 175, respectively. In some embodiments, the oil reservoir 170 and the sample reservoir 175 are each custom stainless-steel reservoirs with plungers driven by high pressure liquid chromatography (HPLC) pumps (e.g., LC20AD, Shimadzu Co., Japan) with water as the hydraulic fluid. In the illustrated embodiment of FIG. 1, the HPLC pumps are illustrated as a plurality of pumps 180. In some embodiments, the MDI 105 includes a plurality of liquid-flow sensors 185 the plurality of pumps 180 and each of the oil reservoir 170 and the sample reservoir 175. In some embodiments, the liquid-flow sensors are SLI-0430 and SLG-0075 liquid-flow sensors (e.g., from Sensirion, Switzerland). In some embodiments, the plurality of pumps 180, the plurality of liquid flow sensors 185, and the oil reservoir 170 and the sample reservoir 175 may be connected using PEEK tubing (e.g., Zeus, USA, 250 μm ID and 1/16-in OD) with fittings and ferrules (e.g., from IDEX Health & Science LLC (USA)).

In some embodiments, such as embodiments conducted at LCLS at the Macromolecular Femtosecond Crystallography (MFX) instrument, the MDI 105 mount on a custom-made bracket provided by LCLS and installed in a Helium-Rich Ambient (HERA) chamber. The HERA chamber regulates helium pressure by a high-pressure gas valve (e.g., Proportion-air, USA). In some embodiments, capillaries, detector fibers, and insulated wires are fed through ports at a side of the HERA chamber. The sample reservoir 175 including the protein crystals is mounted on a modified version of an anti-settler device. Outlets of the oil reservoir 170 and the sample reservoir 175 connect to the droplet generator 120 via assembled 100 μm inner diameter fused silica capillaries.

### Droplet Detector

In some embodiments, the droplet detector 125 includes a 1470 nanometer (nm), 5 milliwatt (mW), single mode (SM), SC/FC terminated pigtailed laser diode (e.g., QPhotonics, USA) as the light beam source. A single-mode bendable optical fiber (e.g., EZ_Bend, OFS, USA) and a multi-mode (MM) optical fiber (e.g., ClearCurve, Corning, USA), both terminate with 1-mm outer-diameter custom zirconia ferrules (e.g., OZ Optics, Canada), deliver and collect light, respectively. In some embodiments, ferrule-terminated patches plug into opposite sides of the droplet detector 125 to transversely illuminate and collect the light transmitted through the droplet detector 125. Refractive index and absorbance differences between the oil and aqueous droplets, and the droplet geometry, produce variations in the transmitted light intensity that is measured using a photodetector (e.g., ADAFC4, ThorLabs, USA).

### Droplet Shape Analysis

The droplet shape and assessment of crystal content may be analyzed for two systems of buffer-only and crystal-containing buffer droplets. In some embodiments, the control hardware 110 analyzes signals indicative of the crystal proteins from the droplet detector 125. In some embodiments, the control hardware 110 analyzes the signals from the droplet detector 125 off-line using a MatLAB code that tallies the absolute and local droplet minima past a set threshold. In some embodiments, the control hardware 110 quantifies signal variation between droplets with and without crystals for 10 minutes (˜72,000 droplets) for each condition and analyzes the number of local minima in each aqueous signal segment.

### Feedback Mechanism

In some embodiments, the control hardware 110 implements droplet frequency and phase control using a Raspberry Pi microcomputer (e.g., Model B, Raspberry Pi Foundation, UK) including a voltage measurement data acquisition (DAQ) hat (e.g., MCC 118, Digilent Inc., USA), a digital delay generator (e.g., DG645, Stanford Research Systems, US), a high voltage amplifier (e.g., Model 2210, Trek Inc., USA), and a Powerlab data acquisition system (e.g., 8/35, AD Instruments, US). In some embodiments, the control hardware 110 analyzes the signals from the photodetector of the droplet detector 125 with data collection using Python scripts applied to the Raspberry Pi, to diagnose droplet frequency and a timing of a leading edge of a droplet relative to an XFEL reference pulse. The control hardware 110 calculates parameter adjustments to maintain the leading edge at a desired position and applies the parameter adjustments to the digital delay generator that drives a droplet electrical trigger for mixing the oil solution and the sample solution to form droplets. Thus, the control hardware 110 controls a fixed delay between the droplets and the XFEL reference over long measurement times. In some embodiments, during XFEL experiments, an attenuator feeds the signals from the photodetector of the droplet detector 125 into a digitizer (e.g., DC282, Acqiris, Switzerland) for droplet signal recording through the MFX (e.g., MFX Experimental Physics and Industrial Control System (EPICS)) system 115.

### Phycocyanin Isolation and Crystallization

In some embodiments, cubic microcrystals of phycocyanin grow on-site in the LCLS Biolabs at the Arrillaga Science Center (ASC) at SLAC National Laboratory (CA, USA). In brief, phycocyanin is isolated from the thermophilic cyanobacterium Thermosynechococcus elongatus as follows: cells (e.g., 50 grams (g)) are harvested from 100 liter (L) cell culture by tangential filtration and disrupted using a microfluidizer (e.g., Microfluidics Model M110-L). Following differential centrifugation to remove unbroken cells, the photosynthetic membranes may be washed 4 times. The third mixture of supernatant is used for isolation of phycocyanin. In some embodiments, Phenylmethylsulfonyl fluoride (PMSF) is added to the supernatant to serve as protease inhibitor (for example, 87 milligram (mg) PMSF dissolves in 1 milliliter (mL) of DMSO and 400 microliters (μL) of is added to 400 mL of supernatant). In some embodiments, the solution clarifies from remaining thylakoid membranes by ultracentrifugation using a Ti45-rotor (e.g., Beckman, USA) with centrifugation at 45,000 rpm at 4° C. for 1 hour. The supernatant is removed and filtered through 0.2 μm filter cups (e.g., VWR Analytical, USA). Subsequently, the phycocyanin purifies by ion exchange chromatography on a Q-Sepharose HP column and equilibrated with buffer A, which may be comprised of 30 mM HEPES pH 7.0. A gradient of buffer B (30 mM HEPES pH 7.0, 200 mM MgCl2) passes through a column with phycocyanin eluting at a concentration of 75 mM MgCl2. Absorbance spectra (e.g., 260-700 nm) is collected from all peak fractions including a fraction that contains pure phycocyanin (e.g., absorption maximum at 620 nm) and free of allophycocyanin contamination (e.g., indicated by a shoulder peak at 650 nm) and other protein contamination (e.g., indicated by a 620 nm to 280 nm ratio >4). All batches are pooled and concentrated to 50 mg/mL using 15 mL Millipore spin concentrators with molecular weight cut-offs at 50 kDa. The concentrated protein is frozen in 100 μL aliquots at −80° C. and ships frozen to the LCLS.

Once onsite, phycocyanin crystallizes using a batch method in sets of 100 μL protein plus 100 μL precipitant. A small stir bar is added to the 500 μL reaction vessel with the 100 μL protein solution (50 mg/mL) in buffer containing 30 mM HEPES pH 7.0 and 75 mM MgCl2. The protein is stirred at 200 revolutions per minute (rpm) and 100 μL of precipitant solution (25% PEG 3350 in 30 mM HEPES and 75 mM MgCl2) is added in 16 steps with a 15 second time delay between steps. In some embodiments, crystals of 5-15 μm grow overnight at RT. For injection purposes, most phycocyanin batches are produced by resuspending the settled crystals in the crystallization solution (12.5% PEG 3350 in 30 mM HEPES and 75 mM MgCl2). Each crystallization experiment thereby yields approximately 200 μL of crystal suspension for sample delivery. Eight crystallization batches are combined and filtered through a 20 μm stainless steel frit with a PEEK ring (e.g., IDEX Health & Science LLC, USA) before being loaded into 1.5 mL sample reservoirs. In some embodiments, a final injection buffer varies in PEG 3350 content from 12.5 to 18%.

### NQO1 Purification and Crystallization

In some embodiments, protein expression and purification of human NQO1 may be carried out as previously described with some modifications. Briefly, Escherichia coli BL21 (DE3) cells transform with pET46 Ek/LIC plasmid containing the cDNA of human NQO1 and grow overnight in 800 mL of lysogeny broth supplemented with 0.1 mg/mL ampicillin (LBA) at 37° C. This starter culture dilutes in 4 L of fresh LBA and grows at 37° C. until the optical density at 600 nm reaches values between 0.6 and 0.8. Expression is triggered by addition of IPTG at a final concentration of 0.5 mM. Induced cells incubate for 4 hours at 28° C., harvested by centrifugation, resuspended in 40 mL of binding buffer (BB: 20 mM sodium phosphate, 300 mM NaCl and 50 mM imidazole at pH 7.4) containing 1 mM PMSF, flash frozen in liquid N2, and stored at −80° C. In some embodiments, the following day, cells are lysed by sonication (e.g., 3 cycles of 2 minutes each, alternating 2 seconds ON/2 seconds OFF with 2 minutes rest on ice). The lysate clears by centrifugation at 30,000 rpm at 4° C. for 40 minutes. The supernatant containing NQO1 filters through 0.45 μm filters and subsequently loads onto an immobilized Ni2+ affinity chromatography column (e.g., Thermo Scientific™ HisPur™ Ni-NTA resin), which was previously equilibrated with BB. After collecting flowthrough, the column washes with 20 column volumes (CVs) of BB and eluted with 10 CVs of elution buffer (e.g., BB containing 500 mM imidazole). The eluted protein dialyzes against 50 mM K-HEPES at pH 7.4. NQO1 protein purifies by size-exclusion chromatography (SEC) using a HiLoad 16/600 Superdex 200 prep grade (e.g., GE Healthcare) using 20 mM K-HEPES, 200 mM NaCl at pH 7.4 containing FAD at a final concentration of 1 mM. Pure protein concentrates to a final concentration of 20 mg/mL using 30 kDa concentrators from Millipore, flash frozen and stores at −80° C. The purity and integrity of the protein is checked by SDS-PAGE.

In some embodiments, prior to the SFX experiment, initial crystallization trials are performed using both the batch and free interface diffusion methods from previously reported crystallization conditions for large crystals as reference. Microcrystals of the human NQO1 may be obtained on-site in the LCLS Biolabs at the Arrillaga Science Center (ASC) at SLAC National Laboratory (CA, USA) by the batch with agitation method as follows: in a 3 mL glass vial, 100 μL of the protein solution at 25 mg/mL is slowly added dropwise to 300 μL of the precipitant solution (0.1 M Tris pH 8.5, 0.2 M sodium acetate, 20% polyethylene glycol (PEG) 3350, and 20 μM FAD) while stirring at 200 rpm. Upon addition of the protein, the solution turns turbid immediately and needle-shaped crystals of dimensions 10×2×2 μm³ grow at room temperature in about 6 hours. An original crystal suspension was spun down at 150 rpm, 25% of the supernatant was removed, and the pellet was resuspended in the remaining volume prior to loading into the sample reservoir 175. Sample A and B result from two different crystallization batches but are otherwise similar.

### Data Collection and Structure Determination

In some embodiments, the MEX instrument 115 receives NQO1 and phycocyanin SFX data at LCLS during beamtime LW79 using the MDI 105 via the droplet detector 125. The droplet detector 125 records diffraction snapshots of the droplets generated at the droplet generator 120. In some embodiments, the droplet detector 125 records the diffraction snapshots via an ePix 10k detector at an X-ray energy of 9.6 keV using a pulse duration of 40 femtoseconds (fs). In some embodiments, a sample-to-detector distance between the droplet detector 125 and the droplet within the droplet channel 165 is approximately 86.3 mm. In some embodiments, the control hardware 110 includes an OM (OnDA (Online Data Analysis) Monitor) for live feedback of crystal and droplet hit rates based on X-ray scattering. In other embodiments, the MEX instrument 115 includes the OM. In addition to X-ray scattering analysis, the OM of the control hardware 110 integrates data from the droplet detector 125. From the integrated droplet data, the control hardware 110 determines a correlation between optical droplet detection of the droplet detector 125 and X-ray interaction with droplets and crystal diffraction. For example, the correlation determined by the control hardware 110 is indicative of droplet hit rates from the X-ray interaction. As an example, for the structure solution of NQO1, the MFX instrument 115 collects a total of 1,533,276 frames, of which 10,269 are classified as hits by the control hardware 110 (for example, using a Cheetah software to determine droplet hits). A more stringent hit-finding procedure with the control hardware 110 (e.g., using a CrystFEL software) identifies 7,598 hits. In such example, about 48% of the identified hits can be indexed, therefore, a total of 4,317 hits are stored as indexed lattices. In some embodiments, the control hardware 110 integrates Bragg reflections (e.g., droplet data, as described above) from the droplet detector 125 using the software package CrystFEL (e.g., version 0.10.1) after indexing attempts. For example, the control hardware 110 may index the integrated droplet data with CrystFEL's indexamajig using algorithms XGANDALF, MOSFLM and DIRAX, in that order. The control hardware 110 converts intensities of the integrated droplet data to structure factor amplitudes. For example, the control hardware 110 may use AIMLESS (from a CCP4 suite package) to convert the integrated droplet data to structure factor amplitudes and includes a fraction of 5% reflections in a generated Rfree set. In some embodiments, the control hardware 110 controls phasing using molecular replacement with PHASER using the PDB code 1DXQ as a search model. In some embodiments, the control hardware 110 refines the obtained model using alternate cycles of automated refinement with REFMAC5 and performs manual inspection with COOT.

In another example, the control hardware 110 applies the same hit finding and indexing procedure for the case of phycocyanin. The MFX instrument 115 collects 625,979 frames, and the control hardware 110 identifies an initial number of 9,257 hits with the CHEETAH software. The control hardware 110 retains 8,172 hits with the CrystFEL software, of which 5,216 are indexed and an individual 7,465 hits are stored as crystal lattices. The control hardware 110 solves and refines the structure as described previously.

### Generating Segmented Droplets

By generating segmented droplets of the sample solution within the oil solution with the droplet generator 120, the MDI 105 reduces sample waste in SFX experiments. For example, the MDI 105 including the droplet generator 120 reduces sample waste with the structure of the enzyme KDO8PS at the SPB/SFX instrument at the EuXFEL in a vacuum chamber and with KDO8PS and lysozyme crystals at the MEX instrument at LCLS. The MDI 105 controls segmented droplet injection by droplet generation via the droplet generator 120, droplet detection via the droplet detector 125, jetting the crystal-laden droplets through the droplet channel 165 into the XFEL path of the droplet detector 125, and synchronizing droplet arrival to the region of interaction with the beam and the XFEL pulses within the droplet detector 125. The MDI 105 includes an order-of-magnitude smaller footprint than current designs. In the MDI 105 of the illustrated embodiment of FIG. 1, the droplets are generated via the droplet generator 120 at less than 3 mm from an orifice of the nozzle 130, with advantages for droplet synchronization discussed below. The control hardware 110 includes droplet generation software and hardware to incorporate a synchronization control strategy for the electrically stimulated droplet release by controlling the plurality of electrode wires 150 to transmit electrically stimulating pulses to the droplets. As described herein, the MDI 105 controls protein injection and serial crystallography relative to NQO1 and phycocyanin. However, it should be understood that the protein injection techniques described herein may be applicable to other proteins.

### MDI Design and Droplet Detector Characteristics

To generate segmented droplets with the MDI 105, the control hardware 110 controls one of the plurality of pumps 180 to displace the oil solution to the oil reservoir 170 and into the oil capillary 135 leading to the droplet generator 120. Similarly, the control hardware 110 controls a separate one of the plurality of pumps 180 to displace the sample solution to the sample reservoir 175 and into the sample capillary 140 leading to the droplet generator 120. The oil solution flows from the oil capillary 135 into the oil channel 155 and the sample solution flows from the sample capillary 140 into the sample channel 160. At the droplet generator 120, crystal-laden droplets of the sample solution form at the intersection of the oil channel 155 and the sample channel 160 and segmented by the oil solution. The MDI 105 controls the droplet generator 120 to form the droplets at a natural frequency based on flow rates from the oil reservoir 170 and the sample reservoir 175, respectively. The droplets flow through the droplet detector 125, into the nozzle 130, and are jetted into the XFEL path. In some embodiments, the distance from the droplet generation within the droplet generator 120 to orifice of the nozzle 130 is 2.5 mm. Given a mechanically noisy environment of the XFEL, generating the droplets as close as possible to the nozzle 130 maintains synchronization between droplets and X-ray pulses.

The MDI 105 integrates the droplet detector 125 for determining a droplet generation frequency of the droplet generator 120 and feedback loop control of the control hardware 110 for droplet synchronization with the XFEL pulses. In some embodiments, optical fibers are inserted into the droplet detector 125 (e.g., inserted into a high-resolution 3D-printed holder section of the droplet detector 125) for detection of the droplets. Inserting the optical fibers into the droplet detector 125 positions the optical fibers with high-precision relative to the droplet channel 165 in the droplet detector 125, while connecting the droplet generator 120 at the top of the droplet detector 125, and the nozzle 130 at the bottom of the droplet detector 125. The droplet channel 165 receives the generated segmented droplets within the oil solution from the droplet generator 120 without interconnecting capillaries. The connection of the droplet generator 120, the droplet detector 125, and the nozzle 130 of the MDI 105 minimizes the distance the droplets travel before reaching the nozzle 130, which maintains synchronization and spatial overlap between the X-ray pulses and crystal-laden droplets generated by the droplet generator. In addition, the droplet detector 125 is attached to the sheathing gas capillary 145 that delivers sheathing gas (for example, Helium (He) gas) to the nozzle 130 for jetting the generated segmented droplets within the oil solution. In some embodiments, the sheathing gas capillary 145 includes a channel that transports the sheathing gas to the nozzle 130 at a periphery of the droplet detector 125.

The droplet detector 125 detects droplets based on refractive index differences between the oil solution and an aqueous buffer of the sample droplets. In some embodiments, the droplet detector 125 detects droplets based on the refractive differences from an incident 1470 nm wavelength laser beam transmitted through the optical fibers. In some embodiments, the walls of the droplet channel 165 transporting the droplets are 100 μm thick, which insignificantly attenuates the signal from the droplet detector 125 as determined with a power meter. The droplet detector 125 transmits a signal indicative of the droplet to the control hardware 110. In some embodiments, the signal is indicative of a droplet shape and a droplet intensity. The droplet shape and the droplet intensity may vary based on the signal.

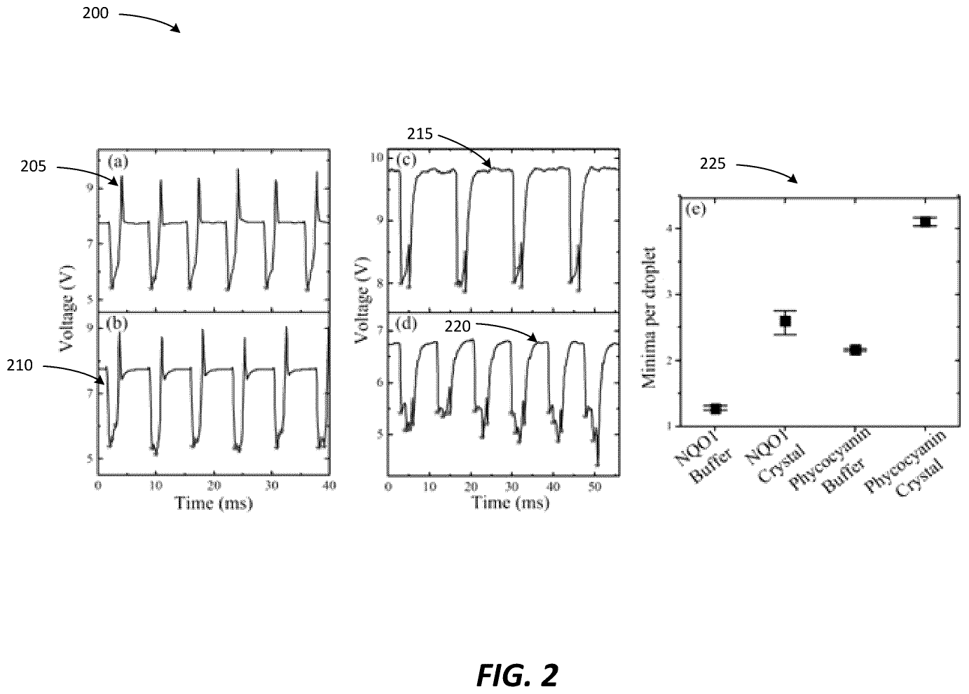

FIG. 2 illustrates a graph 200 showing voltage outputs of the droplet detector 125 for a plurality of droplets from the MDI 105, according to some embodiments. The graph 200 includes a line 205, a line 210, a line 215, and a line 220. The line 205 is indicative of a voltage output of the droplet detector 125 for NQO1 buffer-only droplets. The line 210 is indicative of a voltage output of the droplet detector 125 for NQO1 crystal-containing buffer droplets. The line 215 is indicative of a voltage output of the droplet detector 125 for phycocyanin buffer-only droplets. The line 220 is indicative of a voltage output of the droplet detector 125 for phycocyanin crystal-containing droplets. The graph 200 also includes red stars that indicate local minima of each voltage output for the line 205, the line 210, the line 215, and the line 220. The graph 200 also includes a plot 225. The plot 225 illustrates a comparison of local minima per droplet for buffer-only and crystal-containing droplets for NQO1 and phycocyanin from the line 205, the line 210, the line 215, and the line 220.

Droplets including protein crystals produce signals transmitted from the droplet detector 125 that differ from droplets only including a buffer solution, as illustrated in the embodiment of FIG. 2. Aqueous droplets (including protein crystals for a sample solution or as buffer-only solutions) are shown as valleys in the signals transmitted by the droplet detector 125 since the transmittance of aqueous solutions is lower than that of the oil solution at 1470 nm. The valleys may be bound by sharp peaks caused by refraction at a moving interface of the sample solution and the oil solution, with an intensity and a slope that is based on droplet geometry and composition. The signal corresponding to aqueous buffer-only droplets (e.g., line 205 and line 215) appears as a smooth, reproducible trace. In contrast, the droplets including protein crystals (e.g., line 210 and line 215) appear in irregular ripple patterns in the corresponding signal. The contrast for droplets generated with and without protein crystals is shown in FIG. 2 by line 205 and line 210 for NQO1 and line 215 and line 220 for phycocyanin, respectively. In some embodiments, laser beam absorption and refraction due to variable numbers of protein crystals with different shapes and sizes causes signal ripples. The signals for droplets containing NQO1 or phycocyanin crystals (e.g., line 210 and line 220) illustrate twice as many minima than the signals for buffer-only droplets (e.g., line 205 and line 215) when assessed on ˜72,000 droplets per condition, where the minima in the buffer-only droplets are due only to the leading and ending edges of the droplet, as shown by the plot 225. The protein NQO1 forms needle-shaped crystals with a large aspect ratio (e.g., typically 10×2×2 μm³), while phycocyanin forms cubic crystals (e.g., with sides approximately 20 μm). Regardless of the crystal shape and size, however, the signal variation for crystal-containing droplets is larger than for buffer-only droplets, which verifies that the protein crystals are transported in droplets to the nozzle 130 for injection into the path of the XFEL.

### Droplet Generation and Injection Performance

Droplet release in the droplet generator 120 is electrically triggered by the control hardware 110 to synchronize droplets with the pulsed XFEL. In some embodiments, the droplet generator 120 is located a few mm above the interaction region of the jet of sample solution segmented with the oil solution and the XFEL beam. The distance between the droplet generator 120 and the interaction region may vary due to the assembly of the MDI 105 and XFEL beam alignment. The signals of the droplets transmitted by the droplet detector 125 and measured at the MDI 105 is transmitted into a control loop of the control hardware 110 to correct for any spatial variations and adjust timing of the droplets including protein crystals arrival to the interaction region with the XFEL beam. The control hardware 110 compares the occurrence of the leading edge of the signal indicative of a droplet including protein crystals and the XFEL reference signal. For example, the control hardware 110 may include a Python script implemented on a Raspberry Pi to compare the leading edge and the XFEL reference signal. The control hardware 110 calculates a time difference and adjusts a timing of electrical stimulation to the droplets via the plurality of electrode wires 150, to maintain an optimal droplet edge position, s. In some embodiments, the control hardware 110 updates delay generator parameters (e.g., amplitude, duration, and delay) every 120 droplets. In some embodiments, an output pulse from the delay generator of the control hardware 110 amplifies by a factor of 100 times and the control hardware 110 transmits the output pulse to the plurality of electrode wires 150 at a position within the droplet generator 120 to stimulate droplet release from the droplet generator 120. Electrodes (e.g., electrodes of the plurality of electrode wires 150) are positioned at the intersection of the oil channel 155 and the sample channel 160 in the droplet generator 120, as illustrated in the embodiment of FIG. 1.

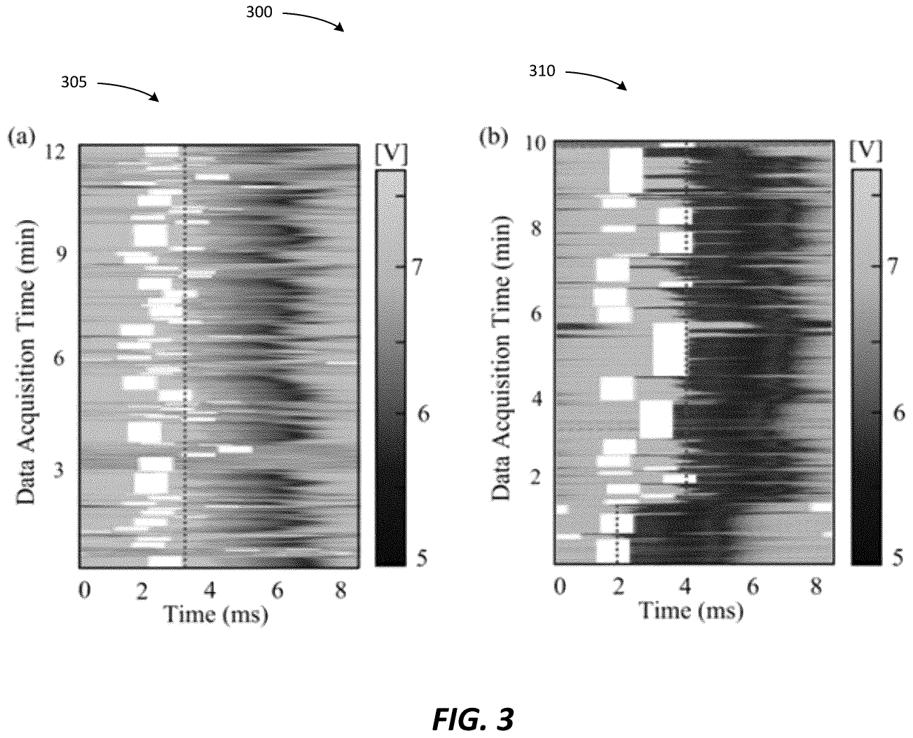

FIG. 3 illustrates a characteristic waterfall plot 300 for continuously triggered and locked-in droplets at 120 Hz at the MEX instrument 115, according to some embodiments. The characteristic waterfall plot 300 illustrates a background of the oil solution in teal, the droplet including protein crystals in deep blue, a trigger signal from the plurality of electrode wires 150 in white, and øs as a red dashed line for continuously triggered and locked-in droplets at 120 Hz. The characteristic waterfall plot 300 includes a plot 305 for NQO1 and a plot 310 for phycocyanin during LW79 at the MFX instrument 115.

The control hardware 110 implements the feedback mechanism as shown with the injection of NQO1 and phycocyanin droplets, as illustrated in FIG. 3 by the plot 305 and the plot 310, respectively. In some embodiments, the characteristic waterfall plot 300 includes heat plots (e.g., the plot 305 and the plot 310) of the signals from the droplet detector 125 stacked at approximately 8.3 ms intervals. A start and an end of each stacked line corresponds to one period of the XFEL reference pulse, e.g., a time between X-ray pulses. The characteristic waterfall plot 300 illustrates a graphical representation of the droplet phase delay, øs, shown in red relative to the XFEL reference pulse. Electrical stimulation timing (e.g., phase) and duration of signals transmitted by the plurality of electrode wires 150 are shown as white bars overlapped on the plot 305 and the plot 310. In the plot 305 and the plot 310, the electrical stimulus duration is 1 ms with an amplitude of 50 V and 150 V, respectively. In some embodiments, the control hardware 110 adjusts an intensity of the electrical stimulus transmitted by the plurality of electrode wires 150 until a minimum voltage that produces a desired effect in droplet frequency, which varies with the buffer composition. For the plot 305 of droplets including NQO1 crystals, the control hardware 110 controls a os of 3.5 ms between the XFEL reference pulse and the leading edge of the droplet. The plot 310 illustrates the waterfall plot for droplets including phycocyanin crystals, where the control hardware 110 sets a target droplet edge position to 2 ms for the first two minutes, and changes to 4 ms for the remaining 8 minutes.

In some embodiments, the control hardware 110 also integrates the droplet feedback mechanism with the LCLS data acquisition system to capture droplet traces through a high-speed digitizer. By integrating into an EPICS data stream (e.g., data from the MEX instrument 115), the control hardware 110 compares droplet injection diagnostics to metrics such as protein crystal hit rate and correlation of programmed øs to droplet hit rates, which may be visualized with the OM. Droplet hit rates indicate a measure of synchronization between droplet arrival at the intersection with the XFEL beam pulse through assessment by the control hardware 110 of scattering differences between the oil solution and the sample solution. To further optimize the synchronization of the droplets with the XFEL using the EPICS interface (e.g., via the MEX instrument 115), the control hardware 110 implements an automated parameter scan to rapidly and reproducibly adjust droplet triggering conditions until maximal crystal diffraction is collected. In some embodiments, the control hardware 110 implements a Python script to control the automated parameter scan.

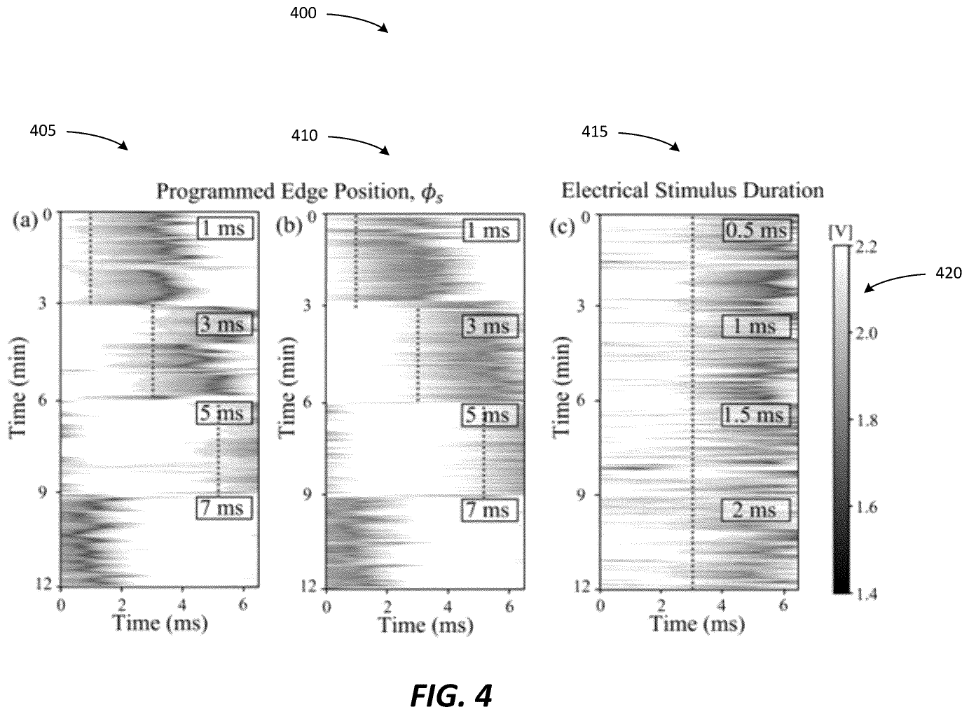

FIG. 4 illustrates a graph 400 showing examples for parameter sweeps to diagnose droplet injection conditions, according to some embodiments. The graph 400 includes a parameter sweep 405 illustrating leading droplet edge position changing from 1 ms to 7 ms in 2 ms steps, each being recorded for a 3 minute run. For the parameter sweep 405, the droplets include NQO1 protein crystals. The graph 400 also includes a parameter sweep 410 illustrating leading droplet edge position changing from 1 ms to 7 ms in 2 ms steps, each being recorded for a 3 minute run. For the parameter sweep 410, the droplets include phycocyanin protein crystals. The graph 400 also includes a parameter sweep 415 that illustrates trigger duration changing across 4 runs for NQO1 from 0.5 ms to 2 ms in steps of 0.5 ms. A greyscale color bar 420 represents amplitude of a droplet signal in volts and the red dotted line Øs.

Electrical stimulation parameters including the duration and amplitude of the electrical stimulus transmitted by the plurality of electrode wires 150 may reproducibly align the leading edge of the droplet to a pre-set øs with parameter sweeps. FIG. 4 illustrates droplet signal traces stacked as waterfall plots resulting from parameter sweeps during NQO1 (the parameter sweep 405 and the parameter sweep 415) and phycocyanin (parameter sweep 410) injection. In some embodiments, the control hardware 110 limits data acquisition to only the first 6.3 ms of the 8.3 ms XFEL period due to the digitizer properties. The parameter sweep 405 illustrates a sweep where the target phase between the droplet leading edge and the XFEL reference is set to 1 ms, 3 ms, 5 ms, and 7 ms, where each maintains for 3 minutes, using a 1 ms long and 70 V electrical trigger pulse transmitted by the plurality of electrode wires 150 while NQO1 is injected in droplets via the droplet generator 120. The leading edges of the droplets within the 8.3 ms XFEL period align as per the programmed delay. For 5 and 7 ms, the leading edge follows the programmed os; however, the droplet appears wrapped around the XFEL reference because the droplet signal overlaps and extends beyond the next XFEL reference.

In some embodiments, the control hardware 110 shifts the leading edge of the droplet in reference to the XFEL pulses with phycocyanin protein crystals, as illustrated by the parameter sweep 410. For the parameter sweep 410, the plurality of electrode wires 150 transmit an electrical stimulus with an amplitude of 130 V and a 1.5 ms duration while the control hardware 110 performs a stepwise sweep of programmed target droplet leading edge of 1 ms, 3 ms, 5 ms, and 7 ms each recorded during a 3 minute run. As in the parameter sweep 405, the parameter sweep 410 illustrates a droplet leading edge change according to the programmed øs. The parameter sweep 405 and the parameter sweep 410 illustrate that øs can be adjusted by the control hardware 110 for different protein crystal samples, which optimizes droplet arrival with respect to the XFEL pulses, as described in greater detail below.

In some embodiments, electrical stimulus duration affects droplet arrival with respect to e XFEL pulses. The parameter sweep 415 illustrates an electrical stimulus duration change from 0.5 ms to 2 ms in steps of 0.5 ms while maintaining the leading edge position of the droplet constant at 3 ms. As illustrated by the parameter sweep 415, shorter 1 ms and 0.5 ms trigger durations include the most stable droplet injection, with the droplet edge position focused around the desired edge position of 3 ms.

In some embodiments, the control hardware 110 controls the automated parameter sweep to scan other electrical stimulus parameters such as amplitude and duration, for optimized synchronization with the XFEL. The MDI 105 releases droplets by an electrical trigger-induced electrowetting effect via the plurality of electrode wires 150. The electrowetting effect occurs upon a trigger amplitude threshold, above which the droplet generation frequency of the droplet generator 120 stabilizes. During a LW79 beam time, the trigger amplitude may be adjusted at a start of every run that uses a new sample or a new device, using stepwise voltage increments until the droplet frequency stabilizes around 120 Hz. In some embodiments, the threshold ranged from 70 V to 200 V. The variability in threshold may be due to the effects of buffer conductivity and small size differences across the components of the MDI 105 affecting the electric field distribution.

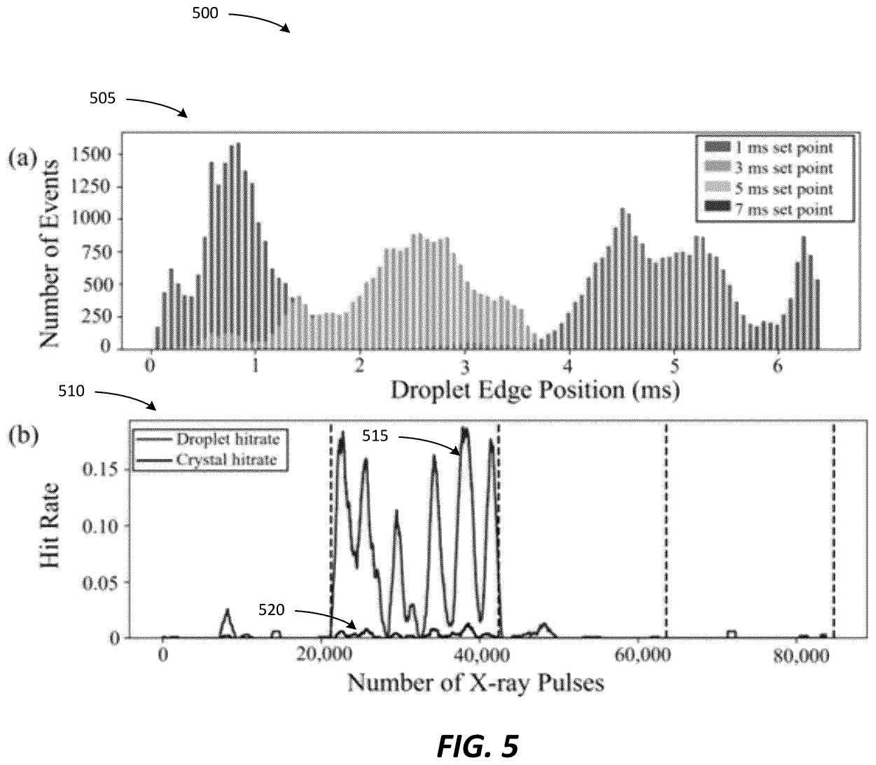

FIG. 5 illustrates a graph 500 showing implementation of a parameter sweep for NQO1 (e.g., the parameter sweep 405 or the parameter sweep 415) with variation of phase delay(s), according to some embodiments. The graph 500 includes a graph 505 illustrating a probability of NQO1 laden droplet leading edge from a parameter sweep for 4 set-points. The graph 500 also includes a graph 510 illustrating a normalized droplet hit rate (a line 515) and crystal hit rate (a line 520) during the parameter sweep for droplets containing NQO1 protein crystals of the graph 505. In some embodiments, the patterns for each ϕₛ were 1 for 1 ms, 153 for 3 ms, 1 for 5 ms and 1 for 7 ms.

In some embodiments, the control hardware 110 correlates the droplet hit rates and the crystal hit rates to the droplet leading edge position based on a parameter sweep. The graph 505 illustrates the number of events with a given leading-edge position in relation to the XFEL reference, measured during a programmed sweep where the target droplet leading edge was set to 1 ms, 3 ms, 5 ms, and 7 ms, each setting maintained for 3 minutes. The frequency distribution of the measured droplet's leading-edge positions is approximately centered around the corresponding set øs, illustrating that setting øs to a value, results in the expected droplet position relative to the X-ray pulse to enable synchronization with the XFEL pulse scheme. The graph 510 shows the crystal hit rates (the line 520) and the droplet hit rates (the line 515) corresponding to the sweep in the graph 505. The line 515 indicates the fraction of patterns for which water solution scattering indicates the presence of the droplet including protein crystals. Both the droplet hit rates and the crystal hit rates are larger when the edge position is 3 ms for the graph 510. In some embodiments, the control hardware 110 optimizes triggering parameters for droplets including phycocyanin crystals. In such cases, a øs of 5 ms results in the largest droplet and crystal hit rates, followed by ϕₛ=3 ms. The graph 500 illustrates controlling the phase of the droplet leading edge through electrically stimulated triggering as a strategy for maximization of hit rates, which applies to protein crystals with different crystallization and injection requirements. The triggering parameter space optimize conditions for synchronizing the timing of the droplet arrival to the intersection with the XFEL pulses during droplet injection SFX experiments, including not only at the 120 Hz pulse frequency of LCLS, but also at XFELs with different pulse structures.

Table 1 (below) compares droplet injection with continuous flow injection with the nozzle 130. While droplet generation via the droplet generator 120 sustains for 6 to 12 hours over the course of one shift, Table 1 summarizes conditions where droplet generation and continuous flow injection are optimized for diffraction data collection.

Injection conditions for two different batches of NQO1 (sample A and B) are detailed in Table 1. For sample A, the overall crystal hit rate is low when injected continuously with the nozzle 130, resulting in an average delivery efficiency of 9.4 indexed patterns per injected μL of sample solution (IP_{Sample}). When the droplet generator 120 generates droplets, but the phase delay is not optimized for droplet hits (ϕₛ=1 ms, 4 ms, or 8 ms), the delivery efficiency drops to 8.0. Active triggering with a non-optimized phase delay reduces the likelihood of sample solution being in the X-ray interaction region when the XFEL pulses arrive (in some instances, the sample hit rate may drop to zero with an ideal injector and incorrect phase). However, Table 1 shows that IP_{Sample} increases when ϕₛ is programmed to 3 ms, in agreement with the parameter sweep demonstrated above. When ϕₛ=2 ms, IP_{Sample} is high compared to injection of the nozzle 130, indicating that the optimized ϕₛ is most likely in between 2 and 3 ms. The high amount of IP Sample may be due to a finite volume of the droplet, which results in a partial overlap with the XFEL pulse and indicates about a 3-fold higher IP_{Sample} compared to continuous injection for the 2 ms case. ϕₛ=3 ms indicates the highest IP_{Sample}, which outperforms continuous GDVN injection by a factor of 4. Since the droplet hit rate with the X-ray pulses is on average 7% with the optimal phase delay of 3 ms, further optimization of the MDI 105 to increase stability and maximize droplet synchronization with the XFEL beam could yield further improvement in sample saving efficiency relative to GDVN systems. Furthermore, the highest diffraction resolution observed for NQO1 is 2.2 Å for both the continuous GDVN and droplet injection via the MDI 105 for sample A, illustrating that the droplet encapsulation in an immiscible oil phase (e.g., the oil solution) does not affect the crystals or that the oil background contribution obscures weaker, high-resolution reflections.

In addition, NQO1 sample B shows the same trends as sample A. When Øs is optimized, there is a 3-fold increase in IP_{Sample} compared to continuous injection. In such cases, IP Sample is lower for the optimized phase delay; however, the diffraction resolution is higher. The lower IP_{Sample} with higher diffraction resolution may indicate that the crystals are smaller in size and may be less concentrated than the batch of sample A.

TABLE 1
Comparison of modular droplet injection and
continuous injection for two batches of NQO1 crystals.

| | | | Sample | Indexed | |
|---|---|---|---|---|---|
| | Injection | ϕs | Flow Rate | Patterns/ | |
| Sample | Method | (ms) | (μL/min) | μL | Resolution |
| A | Droplets | 1, 4, 8 | 3.6 | 8.0 | 2.2 Å |
| | Droplets | 2 | 3.0 | 28.4 | |
| | Droplets | 3 | 3.4 | 39.9 | |
| | Droplets | 4 | 4.0 | 7.5 | |
| | GDVN | — | 20 | 9.4 | 2.2 Å |
| B | Droplets | 1, 2, 4, 5, 7 | 3.7 | 3.3 | 1.9 Å |
| | Droplets | 3 | 3.7 | 9.5 | 1.9 Å |
| | GDVN | — | 20 | 2.2-3.4 | |

### NQO1 SFX Structure

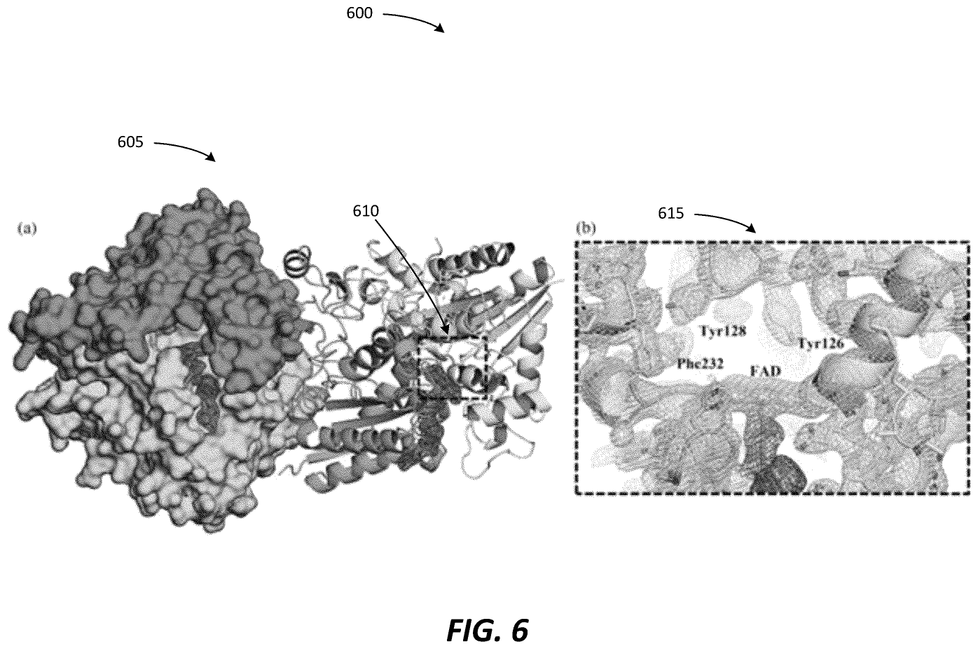

FIG. 6 is an image 600 illustrating a serial femtosecond crystallography (SFX) structure of human NQO1 from the MFX instrument 115, according to some embodiments. The image 600 includes an SFX structure of human NQO1 605 having two dimers of NQO1 in an asymmetric unit. Individual monomers of the human NQO1 are highlighted in green, yellow, orange, and light blue. A cofactor FAD is shown as pink sticks. The SFX structure of human NQO1 605 includes a catalytic site 610 of one of the monomers. The image 600 also includes a catalytic site image 615. The electron 2mF_{c}-DFₒ density maps at the catalytic site 610 contoured at 1σ are shown. Residues Tyr126, Tyr128, and Phe232 which are key in the function of the enzyme are highlighted in the catalytic site image 615. The image 600 indicates the presence of different conformational sub-states prior to NAD (P) H binding and consequent flavin reduction, thus supporting a conformational selection mechanism and providing structure-function information at high resolution.

As explained above with respect to FIGS. 1-5, the MDI 105 implements droplet injection with NQO1 crystals at the MEX instrument 115 with appropriate diagnostics, and the first room-temperature structure of the human NQO1 is solved at 2.7 Å resolution from microcrystals delivered in the sample solution with the MDI 105. In some embodiments, Sample B diffracts to a higher resolution and the collected data via the MEX instrument 115 is highly isomorphic (e.g., the flexibility of a beamline of the MFX instrument 115, can indicate slight variations in the reported unit cell when adjusting the set up during data collection, such as exchanging the nozzle 130). In some instances, the final model of FIG. 6 is refined to a 2.7 Å resolution, with final R_{work} and R_{free} of 21.1% and 24.5%, respectively. The high quality of the NQO1 structure is illustrated from the electron 2mFₒ-DF_{c} density maps shown for the catalytic site residues of the catalytic site 610 and the cofactor FAD, as shown in the catalytic site image 615.

The NQO1 structure quality is evaluated by comparing it with crystal structures reported at cryogenic conditions such as PDB entries 1D4A, 1DXQ, 5A4K, and 5EA2. Overall, all the NQO1 structures aligned very well with each other, with average root-mean-square deviation (RMSD) values of 0.378 Å for the Ca atoms. A global RMSD of 0.867 Å may indicate slightly higher structural differences when the whole protein molecule is considered, mainly due to mismatch from flexible loops as well as solvent exposed regions, as one would expect.

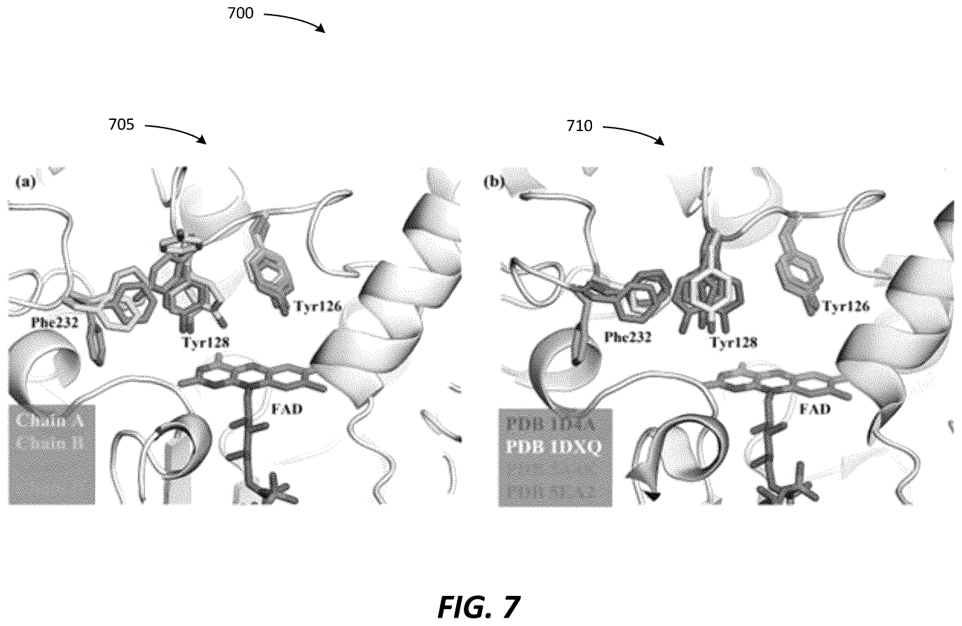

FIG. 7 is an image 700 illustrating superimposition of monomers found in an asymmetric unit of the NQO1 structure from the MEX instrument 115, according to some embodiments. The image 700 includes a superimposition image 705 of the four monomers found in the asymmetric unit of the NQO1 structure determined at the MEX instrument 115. Residues Tyr126, Tyr128, and Phe232, key for NQO1 function, are represented as sticks. FAD is labeled accordingly and represented as pink sticks. The image 700 also includes a superimposition image 710 of the four unliganded cryogenic structures of NQO1 (e.g., PDB 1D4A, PDB 1DXQ, PDB 5A4K and PDB 5EA2). As shown in the superimposition image 705, the key residues and FAD molecule are highlighted.

The image 700 illustrates holo protein structure at room temperature, whereas the published structures were determined under cryogenic conditions with a cryo-protectant. It should be understood that the cryo-protectant, as well as the freezing process, may induce conformational changes that represent a narrow subset of all the possible conformations at room temperature. The differences between room-temperature and cryogenic crystallography structures may be experimentally observed for several proteins. The NQO1 structure of FIG. 7 indicates that residues Tyr128 and Phe232, which play a role in the function of the protein, show an unexpected flexibility within the crystals, as indicated by the superimposition image 705. In contrast, in all the previous cryogenic structures, the Tyr128 and Phe232 residues are typically found in a similar conformation, as indicated by the superimposition image 710. In some instances, the difficulty of obtaining structural and dynamic information by standard macromolecular crystallography at cryogenic conditions at synchrotrons has prevented previous experiments from observing such behavior from a structural perspective. Thus, outputs from the operation of the MDI 105 indicate the two active binding sites of NQO1 acting cooperatively and displaying highly collective inter-domain and inter-monomer communication and dynamics.

The SFX data of FIG. 7 illustrates the conformational heterogeneity of NQO1 at room temperature. The electron density at the catalytic site 610 is shown with an extent of detail, e.g., the Tyr128 and Phe232 residues as shown in FIG. 7, which has not been shown by previous structures determined at cryogenic temperatures. The conformational heterogeneity observed in the room temperature SFX structure of the human NQO1 of the image 700 illustrates a high plasticity of the catalytic site 610. The image 700 may indicate the presence of different conformational sub-states prior to NAD (P) H binding and consequent flavin reduction, thus supporting a conformational selection mechanism and indicating structure-function information at high resolution.

As described above with respect to FIGS. 1-7, droplet generation with the MDI 105 via electrical triggering is optimized and integrates into an EPICS data recording system at the MFX instrument 115. Furthermore, the control hardware 110 optimizes droplet injection parameters of the MDI 105 based on the duration and the amplitude of the electrical stimulus via the plurality of electrode wires 150, and also based on the phase delay of the droplet with respect to the XFEL reference. For both NQO1 and phycocyanin, optimized droplet hit rates (e.g., the line 515) and crystal hit rates (e.g., the line 520), show a larger number of indexed patterns compared to continuous GDVN injection. For NQO1, the larger number of indexed patterns indicates a decrease in sample waste by a factor of four, whereas for phycocyanin, which is injected in a more viscous buffer, a 3-fold improvement is shown. Droplet synchronization efficiency may be increased with additional stabilization of the flow rates at or below 5 μL/min. Since the droplet injection diagnostics are implemented in the data stream at the MEX instrument 115, segmented droplet injection by the MDI 105 may be applicable for other protein crystal samples, not only at the MFX instrument 115 but other XFEL instruments, including vacuum chambers, with which segmented droplet injection is compatible. In addition to the tunability and optimization of droplet generation for SFX at XFELs, the MDI 105 obtains the first SFX room-temperature structure of NQO1 at 2.5 Å resolution.

NQO1 is a biomedically relevant protein that displays functional negative cooperativity. However, there is no structural evidence describing this communication in previous methods. The SFX technique with segmented droplet injection illustrates the structure-function relationships in detail. In addition, the room temperature SFX structure highlights the high conformational heterogeneity of NQO1 in the catalytic site 610, and indicates the molecular basis of NQO1 functional cooperativity previously shown from methods in solution. From an equilibrium point of view, the presence of different conformational substrates (e.g., with potentially different functional properties) illustrates that cooperative effects may arise from a conformational selection mechanism upon ligand binding. Thus, understanding the NQO1 structure-function relationships and interaction with ligands (e.g., substrates and inhibitors) at the molecular level may unravel NQO1's role as an antioxidant and a target to treat common diseases by potent and effective inhibitors in the clinical realm. As described below, in some embodiments, the MDI 105 performs time-resolved SFX in combination with the segmented droplet injection on NQO1 to show the structural changes relation to functionality involved in the catalysis mechanism of NQO1.

### Example

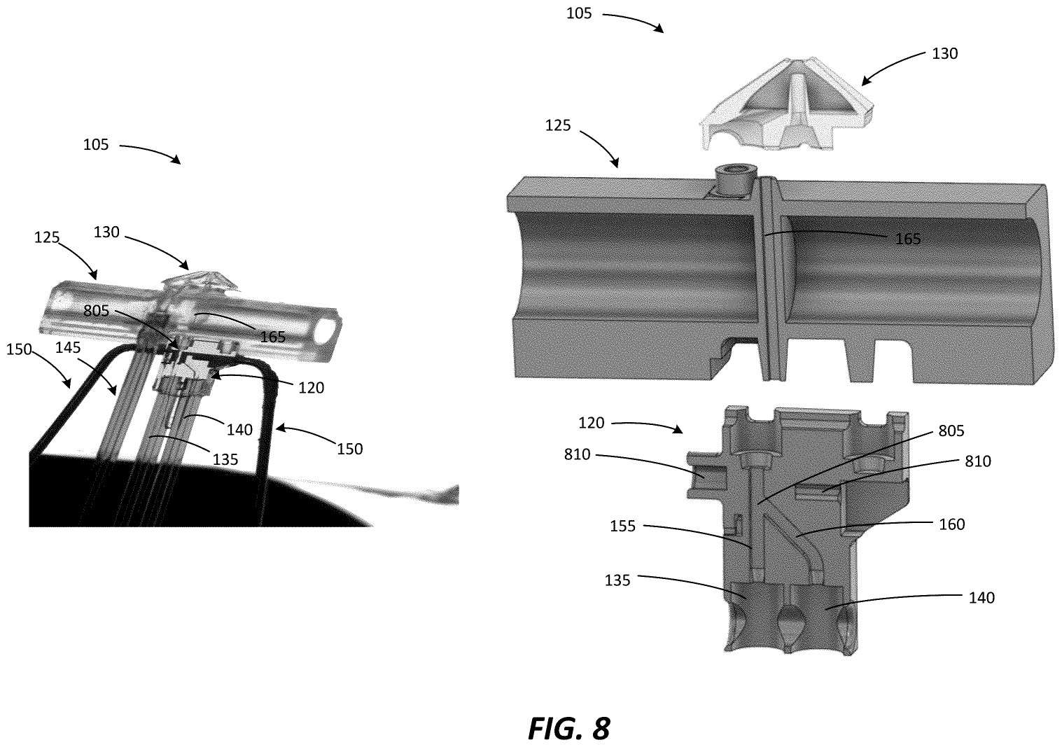

FIG. 8 illustrates the MDI 105 implemented with the MEX instrument 115, according to some embodiments. It should be understood that the MDI 105 illustrated in the embodiment of FIG. 8 includes similar components to the MDI 105 illustrated in the embodiment of FIG. 1. Thus, the MDI 105 illustrated in the embodiment of FIG. 8 operates in a similar manner to the MDI 105 illustrated in FIG. 1. For example, the MDI 105 includes the droplet generator 120, the droplet detector 125, and the nozzle 130. In some embodiments, the droplet generator 120 receives the oil solution from the oil capillary 135 (e.g., the oil channel 155 supplies the oil solution to the droplet generator 120). The droplet generator 120 also receives the sample solution including protein crystals from the sample capillary 140 (e.g., the sample channel 160 supplies the sample solution to the droplet generator 120). In some instances, the sample solution includes a substrate and the protein crystals. In such instances, the MDI 105 mixes the sample solution (e.g., mixes the substrate and the protein crystals) before the droplet generator 120 receives the sample solution. For example, the sample reservoir 175 mixes the substrate and the protein crystals such that the sample capillary 140 receives the sample solution.

In some embodiments, the droplet generator 120 receives both the oil solution and the sample solution at an intersection point 805 of the oil channel 155 and the sample channel 160. The intersection point 805 is a point in the droplet generator 120 where the oil channel 155 and the sample channel 160 converge. As such, the droplet generator 120 mixes the oil solution and the sample solution at the intersection point 805 to generate droplets of the sample solution surrounded by the oil solution (e.g., segmented droplets). In some embodiments, the droplet generator 120 generates the segmented droplets based on a flow rate of the oil solution and a flow rate of the sample solution at the intersection point 805. The droplet generator 120 also includes a plurality of electrode points 810. Each of the plurality of electrode points 810 receives a corresponding one of the plurality of electrode wires 150. The plurality of electrode points 810 include electrodes of the plurality of electrode wires 150 positioned near the intersection point 805. As the segmented droplets flow past the intersection point 805, the control hardware 110 transmits a signal indicative of an electrical stimulus to the plurality of electrode wires 150. The electrodes of the plurality of electrode wires 150 transmit the electrical stimulus to the segmented droplets at the plurality of electrode points 810. The electrical stimulus from the electrodes of the plurality of electrode wires 150 propels (e.g., jets) the segmented droplets to the droplet detector 125. In some embodiments, the control hardware 110 transmits the signal based on a frequency of XFEL pulses. As such, the jetting of the segmented droplets from the droplet generator 120 coincides with the XFEL pulses.

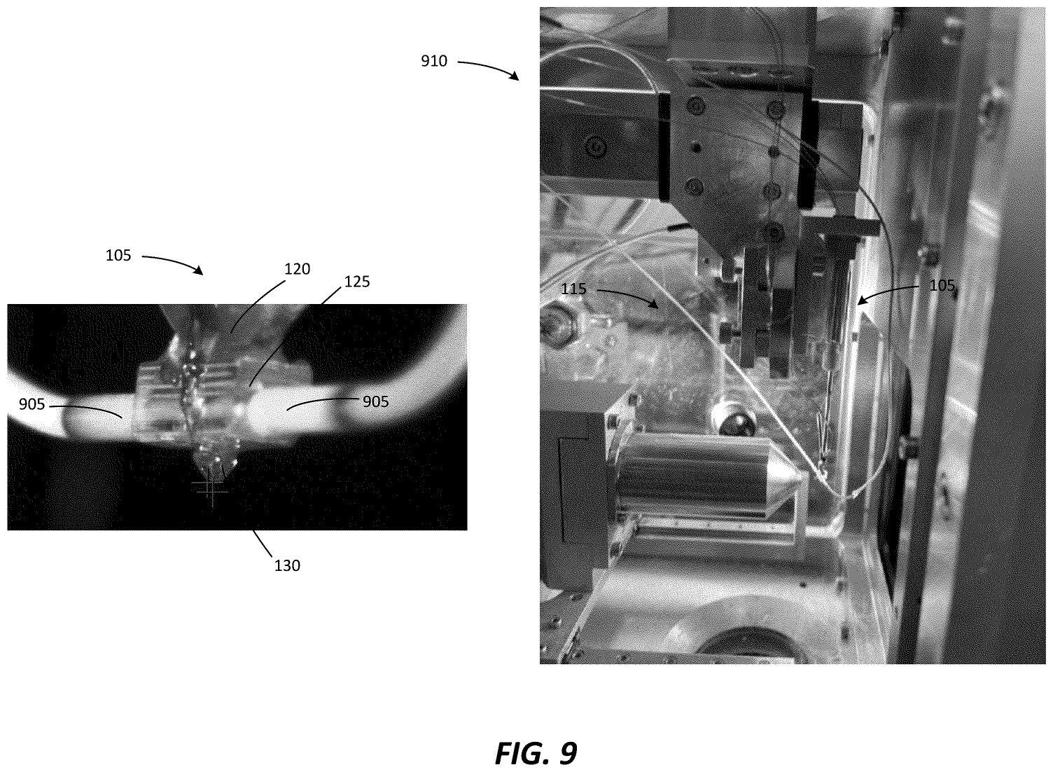

The segmented droplets flow from the droplet generator 120 to the droplet channel 165 and through the droplet detector 125. The droplet detector 125 senses (e.g., detects) a presence of a segmented droplet using a plurality of optical fibers (FIG. 9), as described above. In some embodiments, the droplet detector 125 transmits a signal indicative of the presence of a segmented droplet to the control hardware 110. Based on the signal indicative of the presence of the segmented droplet, the control hardware 110 controls the transmission of the signal including the electrical stimulus to the plurality of electrode wires 150. As such, the control hardware 110 adjusts a flow rate of the segmented droplets to interact with the XFEL pulses.

The segmented droplets flow through the droplet channel 165 from the droplet detector 125 to the nozzle 130. At the nozzle 130, the segmented droplets mix with the sheathing gas from the sheathing gas capillary 145. The nozzle 130 jets the segmented droplets with the sheathing gas out of the MDI 105 to interact with the XFEL pulses.

In some embodiments, the control hardware 110 adjusts the transmission of the signal including the electrical stimulus to the plurality of electrode wires 150 to perform time-resolved SFX with the segmented droplets. In some embodiments, the control hardware 110 adjusts the flow rate of the segmented droplets such that the segmented droplets interact with the XFEL pulses at different points in time of a reaction between the substrate and the protein crystals. The control hardware 110 transmits a first signal including a first electrical stimulus to the plurality of electrode wires 150 such that the segmented droplets flow at a first flow rate. Based on the first flow rate, the segmented droplets interact with the XFEL pulses at a first point in time of the reaction. In some embodiments, the control hardware 110 transmits a second signal including a second electrical stimulus to the plurality of electrode wires 150 such that the segmented droplets flow at a second flow rate. Based on the second flow rate, the segmented droplets interact with the XFEL pulses at a second point in time of the reaction. Accordingly, SFX may be performed with the segmented droplets at different points in time of the reaction between the substrate and the protein crystals using the MDI 105.

FIG. 9 illustrates the MDI 105 implemented with the MEX instrument 115 of FIG. 8, according to some embodiments. The MDI 105 includes the droplet generator 120, the droplet detector 125, and the nozzle 130. The MDI 105 also includes a plurality of optical fibers 905 connected to the droplet detector 125. As described above, the droplet detector 125 senses the presence of the segmented droplet using the plurality of optical fibers 905. FIG. 9 also illustrates an image 910 showing the MDI 105 implemented with the MEX instrument 115.

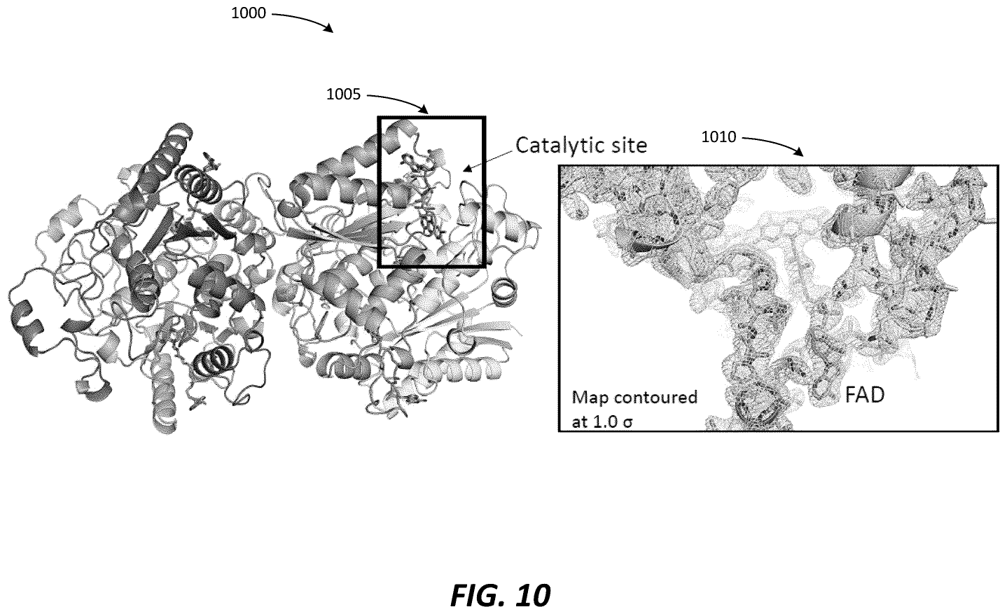

FIG. 10 is an image 1000 illustrating a room temperature X-ray Free Electron Laser (XFEL) NQO1 structure from the MDI 105, according to some embodiments. The image 1000 shows the reaction of NQO1 with its coenzyme NADH and includes a catalytic site 1005. The image 1000 also includes a catalytic site image 1010 showing a density map of the catalytic site 1005 and the cofactor FAD.

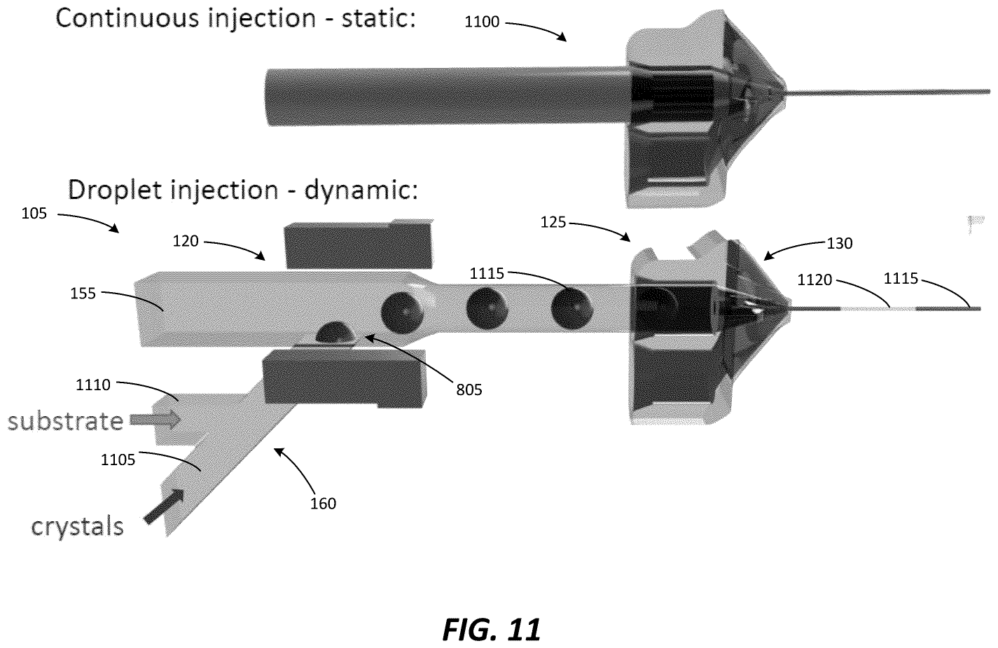

FIG. 11 illustrates an integrated mixer and nozzle of the MDI 105, according to some embodiments. The embodiment illustrated in FIG. 11 compares a continuous injection generator 1100 with the MDI 105. As illustrated in the embodiment of FIG. 11, the continuous injection generator 1100 continuously jets the sample solution. In contrast, the MDI 105 jets the sample solution intermittently with the oil solution to conserve the amount of the sample solution used. In the embodiment illustrated in FIG. 11, the droplet generator 120 receives the oil solution from the oil channel 155 and the sample solution from the sample channel 160. In some embodiments, the droplet generator 120 mixes the substrate and the protein crystals at the sample channel 160. For example, the droplet generator 120 includes a protein crystal channel 1105 and a substrate channel 1110. The protein crystal channel 1105 and the substrate channel 1110 converge to the sample channel 160. As such, the sample channel 160 receives the protein crystals from the protein crystal channel 1105, the substrate from the substrate channel 1110, and mixes the protein crystals and the substrate into the sample solution. The sample solution flows along the sample channel 160 to the intersection point 805 and the droplet generator 120 generates the segmented droplets (e.g., a plurality of segmented droplets 1115) surrounded by the oil solution (e.g., an oil solution 1120). The plurality of segmented droplets 1115 and the oil solution 1120 flow to the droplet detector 125 and jet out of the nozzle 130, as described above.

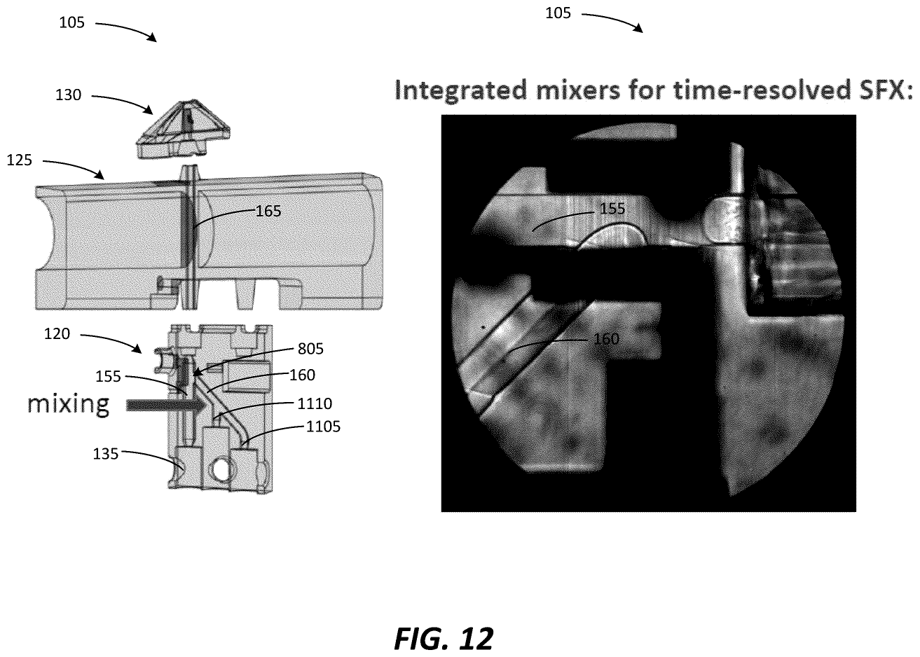

FIG. 12 illustrates an integrated mixer and nozzle of the MDI 105, according to some embodiments. As described with respect to the illustrated embodiment of FIG. 11, the droplet generator 120 includes the protein crystal channel 1105 and the substrate channel 1110. In some embodiments, the droplet generator 120 mixes the protein crystals and the substrate at the sample channel 160. The oil channel 155 and the sample channel 160 converge at the intersection point 805. As described above, the droplet generator 120 generates the segmented droplets at the intersection point 805.

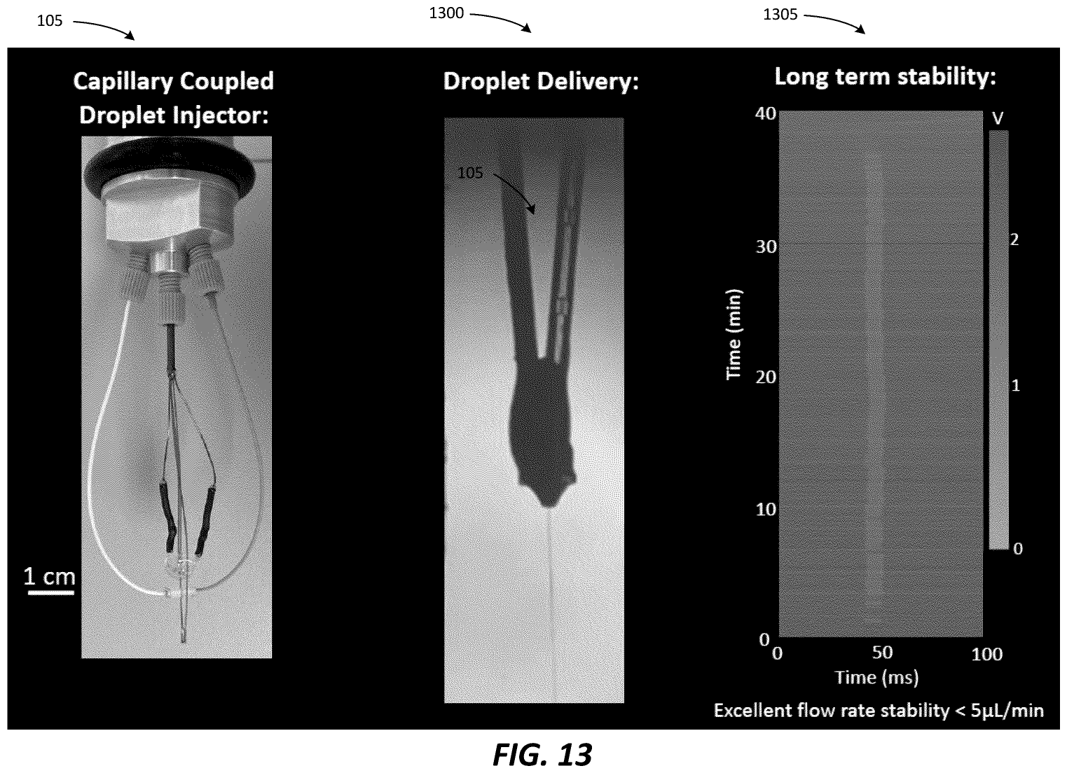

FIG. 13 illustrates the MDI 105 for a Single Particles, Clusters, and Biomolecules & Serial Femtosecond Crystallography (SPB/SFX) instrument, according to some embodiments. FIG. 13 also illustrates an image 1300 showing segmented droplet delivery from the MDI 105. In addition, FIG. 13 illustrates an image 1305 showing flow rate stability of the MDI 105. The image 1305 shows that the MDI 105 has long term flow rate stability with a flow rate stability of less than 5 L/min.

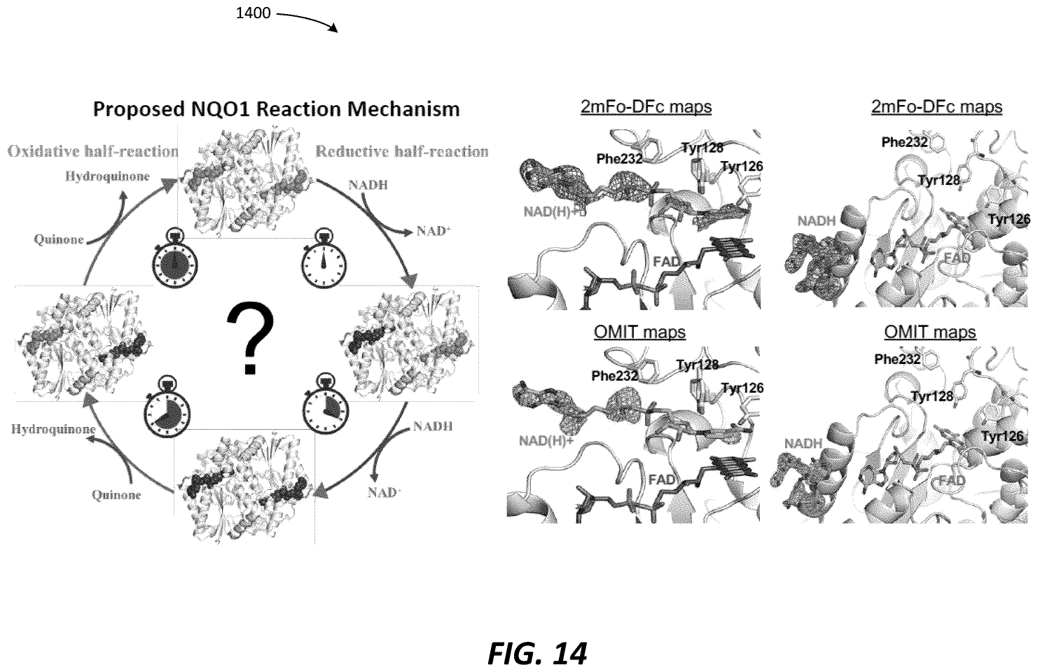

FIG. 14 is an image 1400 illustrating time-resolved SFX of an NQO1 structure with the MDI 105, according to some embodiments. In the illustrated embodiment of FIG. 14, SFX occurs using segmented droplets from the MDI 105. The image 1400 shows the substrate NADH bound with NQO1 following segmented droplet injection from the MDI 105. In the illustrated embodiment of FIG. 14, NQO1 is mixed with the substrate NADH at 264 ms with 5,300 indexed patterns. As such, approximately 3 mg of NQO1 are consumed which saves approximately 90% of NQO1 compared to continuous injection generators.

### Example

### Materials and Methods

Embodiments described herein may include the use of Perfluorodecalin (PFD) and 1H,1H,2H,2H-perfluoro-1-octanol (perfluorooctanol, PFO) (e.g., from Sigma-Aldrich (St. Louis, USA)). Embodiments described herein may include the use of SU-8 developer (e.g., from Microchem (Round Rock, USA)). Embodiments described herein may include the use of photoresist IP-S (e.g., from Nanoscribe GmbH (Eggenstein-Leopoldshafen, Germany)). Embodiments described herein may include the use of deionized water (e.g., 18 MΩ) was (from an LA755 Elga purification system (Elga Lab water, High Wycombe, USA)) and isopropyl alcohol (IPA) and ethanol (e.g., from VWR International (Radnor, USA) or Decon Labs (King of Prussia, USA)). Embodiments described herein may include the use of fused silica capillaries (e.g., 360 μm outer diameter, 100 μm inner diameter) (e.g., from Molex (Lisle, USA)). Embodiments described herein may include the use of Hardman extra-fast setting epoxy glue (e.g., from All-Spec (Houston, USA)).

Embodiments described herein may include the use of E. coli BL21 (DE3) competent cells (e.g., from Agilent technologies (USA)). Embodiments described herein may include the use of yeast extract and tryptone (e.g., from Condalab (Madrid, Spain)). Embodiments described herein may include the use of EDTA-free Protease Inhibitor Cocktail, Isopropyl β-D-1-thiogalactopyranoside (IPTG), ampicillin, sodium phosphate, sodium chloride, imidazole, flavin adenine dinucleotide (FAD), sodium acetate, K-HEPES, and Tris-HCl (e.g., from Merck (Madrid, Spain)). Embodiments described herein may include the use of Polyethylene glycol (PEG) 3350 (e.g., from Hampton Research (USA)), and nicotinamide adenine dinucleotide (NADH) (e.g., from Merck (Madrid, Spain)).

### Mixer Device Design and Fabrication

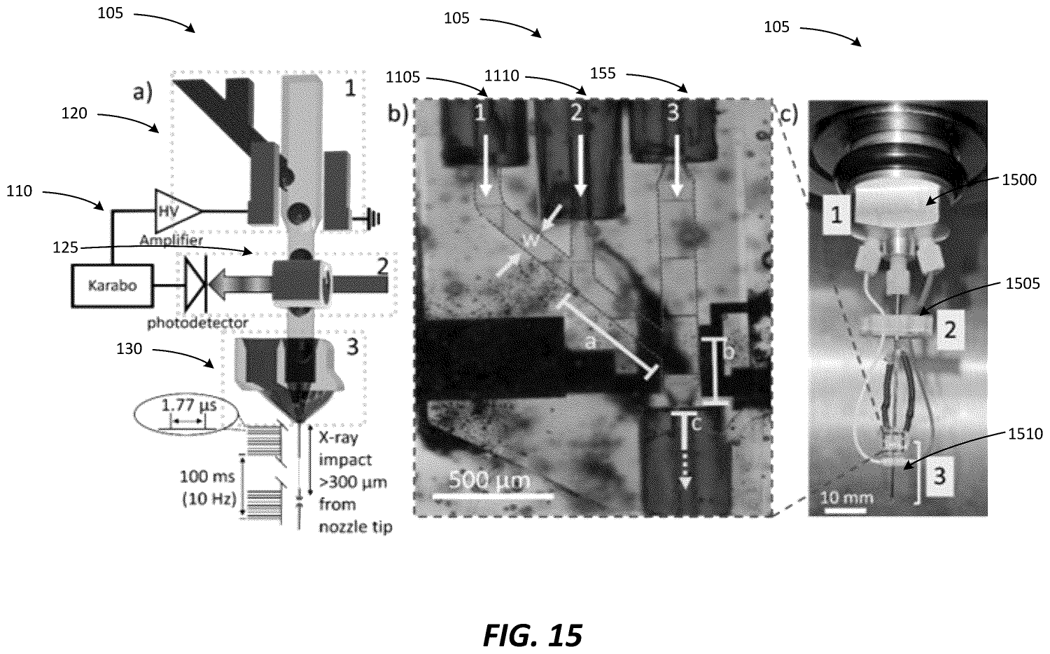

FIG. 15 illustrates an MDI setup (including the MDI 105) with control hardware (e.g., the control hardware 110) and X-ray interaction region in an SPB/SFX instrument, according to some embodiments. As described above, the MDI 105 mixes protein crystals with a substrate for time-resolved studies. The MDI 105 includes the droplet generator 120, the droplet detector 125, and the nozzle 130. The droplet generator 120 includes a Y-shaped mixer (e.g., the protein crystal channel 1105 and the substrate channel 1110) and electrodes (e.g., via the plurality of electrode wires 150) as described previously. The droplet detector 125 includes the plurality of optical fibers 905, and the MDI 105 also includes the nozzle 130. In some embodiments, the MDI 105 connects the droplet generator 120, the droplet detector 125, and the nozzle 130 with joining fused-silica capillaries and glued together using epoxy glue.

FIG. 15 also illustrates the protein crystal channel 1105, the substrate channel 1110, and the oil channel 155, as described above. In some embodiments, dimensions include w=100 μm (e.g., width of the sample channel 160), a=528 μm (e.g., length of the sample channel 160 within the droplet generator 120 where substrate and crystal streams mix), b=285 μm (e.g., length of the oil channel 155 where aqueous streams form a droplet segmented by the oil phase), and c=15.4 mm (e.g., length of the remaining MDI 105 to the orifice of the nozzle 130. FIG. 15 also illustrates the MDI 105 mounted on the EuXFEL, including an adapter 1500 and a fiber bracket 1505 securing the MDI 105 and fibers 1510 (e.g., the protein crystal channel 1105, the substrate channel 1110, and the oil channel 155) during insertion and experimentation.

In some embodiments, the components of the MDI 105 are created using Fusion 360 (e.g., from AutoDesk, San Francisco, USA) and subsequently 3D printed with a Photonic Professional GT 3D printer (e.g., Nanoscribe GmbH, Eggenstein-Leopoldshafen, Germany), using IP-S photoresist. After printing, the components of the MDI 105 are developed in SU-8 developer followed by rinsing in IPA. Similar protocols may be used for the nozzle 130.

In some embodiments, the droplet generator 120 includes the protein crystal channel 1105, the substrate channel 1110, and the oil channel 155 that converge in a series of Y-junctions, as shown in FIG. 15. The oil channel 155 delivers the oil solution that segments the droplets, the protein crystal channel 1105 delivers the protein crystals suspended in mother liquor, and the substrate channel 1110 delivers the substrate dissolved in the mother liquor. In some embodiments, the oil solution is a 10:1 v/v mixture of PFD to PFO.

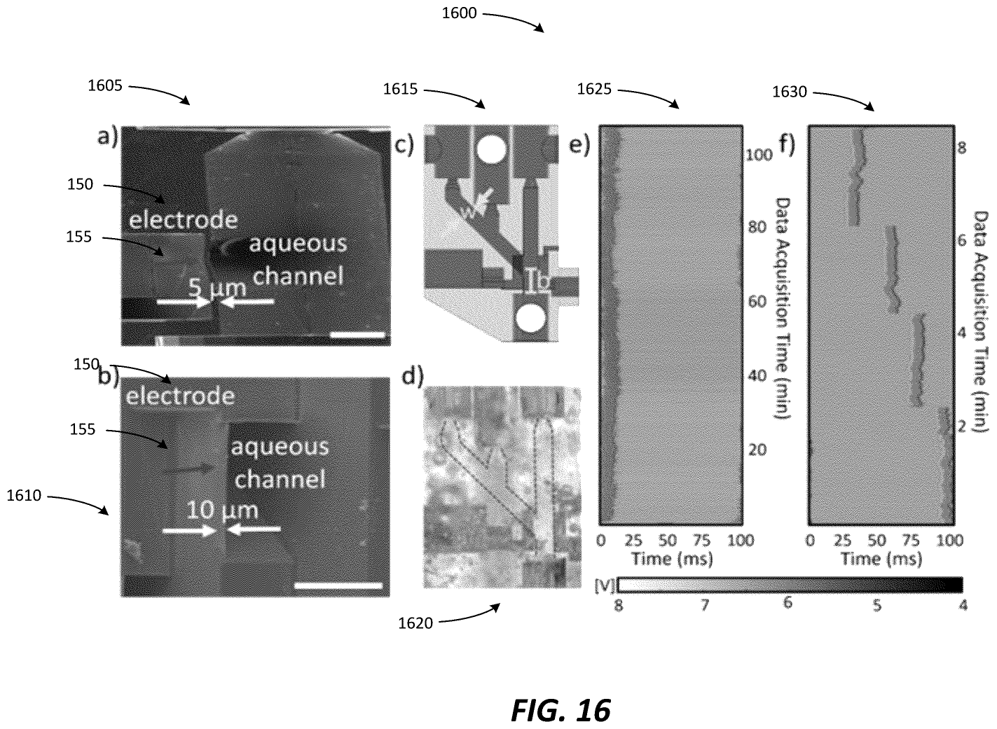

In some embodiments, the protein crystal channel 1105 and the substrate channel 1110 are 100 μm×100 μm in cross-section that join the oil channel 155 with a cross-section of 150 μm×150 μm. In other embodiments, the MDI 105 includes the protein crystal channel 1105, the substrate channel 1110, and the oil channel 155 of all the same cross-section of 150 μm×150 μm (FIG. 16).

As mentioned above, in some embodiments, the control hardware 110 adjusts the transmission of the signal including the electrical stimulus to the plurality of electrode wires 150 to perform time-resolved SFX with the segmented droplets. In some embodiments, the control hardware 110 adjusts a first flow rate of the oil solution or a second flow rate of the substrate solution and the protein crystal solution (e.g., crystal solution) such that the segmented droplets interact with the XFEL pulses at different points in time of a reaction between the substrate (e.g., substrate solution) and the protein crystals (e.g., crystal solution). In some embodiments, the droplet generator 120 includes a first intersection point where the substrate channel 1110 and the protein crystal channel 1105 converge. At the first intersection point, the droplet generator 120 mixes the sample solution and the protein crystal solution to initiate a reaction between the substrate solution and the crystal solution in the sample solution. At the second flow rate, the reaction includes a first delay (e.g., a first point in time to interact). For example, a rate of the reaction occurs accordingly to the second flow rate because the second flow rate initiates the reaction. Based on the second flow rate, the segmented droplets interact with the XFEL pulses at the first point in time of the reaction. At a second intersection point (e.g., the intersection point 805), the droplet generator 120 generates the segmented droplet of the sample solution surrounded by the oil solution at the intersection point 805 based on the first flow rate and the second flow rate. Based on the second flow rate, SFX occurs on the segmented droplet including the reaction at the first delay (e.g., at the first point in time of the reaction). In some embodiments, the substrate solution and the protein crystal solution interact at the first intersection point at a third flow rate (e.g., the control hardware 110 controls the flow rate of the substrate solution and the protein crystal solution to be the third flow rate). Based on the third flow rate, the segmented droplets interact with the XFEL pulses at a second point in time of the reaction. As such, the reaction includes a second delay (e.g., a second point in time to interact). For example, the rate of the reaction occurs according to the third flow rate because the third flow rate initiates the reaction. Based on the third flow rate, SFX occurs on the segmented droplet including the reaction at the second delay (e.g., at the second point in time of the reaction). Accordingly, SFX may be performed with the segmented droplets at different points in time of the reaction between the substrate and the protein crystals using the MDI 105. It should be understood that SFX may be performed as described above for as many different points in time of the reaction as possible.

FIG. 16 is an image 1600 illustrating channels of an MDI setup (e.g., the MDI 105) and corresponding waterfall plots, according to some embodiments. The image 1600 shows an image 1605 of an internal structure of the MDI 105 where a deformation in a 5 μm wall is indicated in red between the oil channel 155 and the plurality of electrode wires 150. FIG. 16 also shows an image 1610 of an internal structure of the MDI 105 where the oil channel 155, now 10 μm thick, is indicated in red, but not deformed. Aspect ratios in each image differ and the scale bar represents 200 μm. The image 1600 also includes an image 1615 and an image 1620 of the MDI 105 at the EuXFEL. FIG. 16 also includes a waterfall plot 1625 in a droplet generation device without the MDI 105, with Q_{O}=18.2 μL/min, Q_{B}=1.5 L/min, trigger amplitude of 100 V and duration of 10 ms and a waterfall plot 1630 from the MDI 105 at Q_{O}=18.5 μL/min, Q_{B}=1 μL/min, trigger amplitude of 200 V and duration of 10 ms with various triggering phases after the changes in geometry and surface treatment from image 1610. For the waterfall plot 1625 and the waterfall plot 1630, a droplet detector signal is divided into 100 ms sections according to the XFEL-reference pulse at 10 Hz, and each trace is aligned in a vertical stack with the color representing the amplitude of the signal.

### SEM Imaging

In some embodiments, scanning electron microscopy (SEM) imaging is used at the Eyring Materials Center at Arizona State University, using the Zeiss Auriga FIB/SEM (Germany). In some embodiments, components of the MDI 105 print with an open structure in the region of interest and then sputter-coated with gold. The SEM instrument operates at 5.0 kV and the sample is tilted to inspect the wall between plurality of electrode wires 150 and respective fluid channels.

### Fluidic Operation and SPB/SFX Configuration

In some embodiments, oil and crystal samples were driven from oil and sample reservoirs (e.g., the oil reservoir 170 and the sample reservoir 175) by HPLC pumps (e.g., from LC20AD, Shimadzu Co., Kyoto, Japan) or syringe pumps (e.g., from neMESYS 1000, Cetoni, Korbussen, Germany) as the plurality of pumps 180. In some embodiments, the plurality of flow sensors 185 (e.g., from mini CORI-FLOW™ ML120V00, Bronkhorst, Bethlehem, USA, and LIQUI-FLOW™ Mini, Bronkhorst, Bethlehem, USA) monitor flow rates in liquid lines before the oil reservoir 170 and the sample reservoir 175. In some embodiments, PEEK tubing (e.g., from Zeus, Orangeburg, USA, 250 μm ID, and 1/16-in OD), along with fittings and ferrules (e.g., from IDEX Health & Science LLC (Oak Harbor, USA)), connect the plurality of flow sensors 185, the oil reservoir 170 and the sample reservoir 175, and tubing. In some embodiments, fused silica capillaries connect to the oil reservoir 170, the sample reservoir 175, and the droplet generator 120.

In some embodiments, for beam times P4502 and P3083 at the SPB/SFX instrument of the EuXFEL, the MDI 105 mounts to the adapter 1500 at the end of a nozzle rod and lowered into the vacuum chamber through the instrument's load-lock system. Capillaries and insulated wires feed through a steel tube affixed to a center of the adapter 1500, while fibers thread through two additional side ports, as shown in FIG. 15. The sample reservoir 175 mounts on a rotating shaker device (e.g., a PTR-360, Radnor, VWR). Gas (e.g., Helium) pressure for the nozzle 130 regulates by a GP1 electronic pressure regulator (e.g., from Equilibar, Fletcher, USA) and monitors by plurality of flow sensors 185 (e.g., from EL-FLOW Select F-111B, Bronkhorst, Bethlehem, USA).

### Feedback Mechanism

In some embodiments, during experiments conducted at the EuXFEL, the droplet monitoring and triggering feedback mechanism integrates in the control hardware 110 (e.g., with Karabo, an in-house control system at the EuXFEL). In some embodiments, the triggering feedback mechanism is similar to FIG. 1, as described above. In some embodiments, all controls integrate, trace droplets, record by a SIS8300 digitizer (e.g., from Struck Innovative Systeme GmbH, Hamburg, Germany), and additional diagnostic information records and saves within the EuXFEL data stream (e.g., the MFX instrument 115) for post-experimental processing.

### Numerical Modeling

In some embodiments, numerical modeling assesses the spread of the reaction time point with COMSOL Multiphysics Ver. 6.2 (e.g., from COMSOL, Burlington MA, USA). The control hardware 110 uses a 2D model of the sample channel 160 to simulate the diffusion for the substrate molecule in the convective flow near the intersection point 805. To assess the substrate concentration in the droplet forming at the intersection point 805, the geometry corresponds to the sample channel 160 and the oil channel 155 joined at a 45° angle designed in AutoCAD (e.g., from AutoDesk, San Francisco, CA, USA).

In some embodiments, the 2D simulation of the sample channel 160 uses a Laminar Flow module (for pressure-driven flow) to establish the flow profile and the Transport of Diluted Species module for modeling convection and diffusion. The control hardware 110 models droplet formation for the sample channel 160 and the oil channel 155, with the dimensions outlined in Table 2. The Laminar Flow module, uses the Level Set module for two-phase flow for droplet generation, and the Transport of Diluted Species module to model diffusion-convection mixing. The control hardware 110 uses a mesh with the “extremely fine” setting applied over the full length of the sample channel 160 and the oil channel 155 and the duration is 1.35 s with 1 ms step size for the one embodiment of the MDI 105 and 0.78 s with 0.5 ms step size for a second embodiment of the MDI 105, respectively. The details of boundary conditions, relevant equations, and parameters are shown Table 2.

TABLE 2
Boundary conditions, relevant equations, and modified parameters used for simulations.

| Physics | Boundary Conditions and Modified Parameters |
|---|---|
| Laminar Flow | Surface Domain: |
| | 0 = −∇p + μ∇²u |
| | ρ∇ · (u) = 0 |
| | Wall: |
| | u = 0 (No slip condition) |
| | 2D geometry: |
| | - 100 × 528 μm or 150 × 528 channel geometry for |
| | aqueous sample inlet (corresponding to DG250-Y-Mixer or |
| | DG300-Y-Mixer, respectively) |
| | - 150 × 1435 μm channel geometry for oil inlet (DG300-Y- |
| | Mixer) |
| | - 150 × 1385 μm channel geometry for oil inlet (DG250-Y- |
| | Mixer) |
| | - The aqueous channel joined to the oil channel at a 45° |
| | angle. |
| | Inlet: Fully Developed Flow (Flow rate in m³/s) |
| | Boundary condition = laminar inflow |
| | Outlet: p₀ = 0 |
| Level Set | Surface Domain (Phase initialization): |
| | $\frac{\partial ϕ}{\partial t} + u \cdot ∇ ϕ = γ ∇ \cdot ( ε ∇ ϕ - ϕ ( 1 - ϕ ) \frac{\partial ϕ}{\vert ∇ ϕ \vert} )$ |
| | Initial Value and Inlet for the oil phase ϕ = 0 |
| | Initial Value and Inlet for the aqueous phase ϕ = 1 |
| | γ: 0.0146 m/s |
| | ηₒᵢₗ: 6.56 cP |
| | η_{aqueous}: 5.39 cP |
| | ρₒᵢₗ: 1.8 g/m³ |
| | ρ_{aqueous}: 1 g/m³ |
| | Surface Tension Coefficient: 14 mN/m |
| | Wetted wall: θ = 2.36 [Rad] for DG 300-Y-Mixer and 2.53 [Rad] |
| | for DG250-Y-Mixer. |
| Transport of Diluted | Surface Domain |
| Species | ∇ · (Jᵢ + ucᵢ) = Rᵢ of species i |
| | Jᵢ = −Dᵢ∇cᵢ |
| | c_{substrate} = 300 mol/m³ |
| | D_{substrate} = 6.7*10⁻¹⁰ m²/s |
| Nomenclature | ϕ = level set function |
| | u = Velocity vector of fluid |
| | u = fluid velocity [m/s] |
| | p = pressure [Pa] |
| | t = time [s] |
| | μ = dynamic fluidic viscosity [Pa·s] |
| | cᵢ = Concentration of species i [mol/m³] |
| | c_{sub} = Concentration of substrate [mol/m³] |
| | Jᵢ = Relative mass flux vector of species i |
| | Dᵢ = Diffusion coefficient of species i |
| | D_{sub} = Diffusion coefficient of substrate [m²/s] |
| | γ = Reinitialization Parameter [m/s] |
| | ηₒᵢₗ = Viscosity of oil [cP] |
| | η_{aqueous} = Viscosity of aqueous sample (crystal + substrate) [cP] |
| | ρ_{aqueous} = Density of aqueous sample [g/m³] |
| | θ = Contact angle [Rad] |

### Protein and Crystal Sample Preparation

In some embodiments, protein and crystal sample preparation for use with the MDI 105 may be as follows: for beamtime P3083, microcrystals of the free NQO1 may be obtained on-site in the XBI labs of the EuXFEL using the batch with agitation method as follows: in a 3 mL glass vial, 100 μL of the protein solution at 18 mg/mL is slowly added dropwise to 300 μL of the precipitant solution (e.g., 0.1 M Tris pH 8.5, 0.2 M sodium acetate, 25% polyethylene glycol (PEG) 3350) while stirring at 200 rpm. Upon addition of the protein, the solution turns turbid immediately and needle-shaped crystals of an average size of 40 μm in a longest dimension grew at room temperature in about 1 hour. Before loading the sample into the sample reservoir 175, the microcrystal samples filter through an inline filter (e.g., 20 μm pore size) and concentrate four times by centrifugation at 3,000 rpm for 2 minutes to settle crystals. In the case of beamtime P4502, smaller microcrystals of 10-20 μm in a longest dimension may be grown on-site by adding a protein solution at a higher concentration (e.g., 26.5 mg/mL). Before loading the sample into the sample reservoir 175, the microcrystal samples filter through an in-line filter with a mesh cut-off size of 26 μm×26 μm and concentrate four times by letting the microcrystals settle for about 4 hours and subsequently removing the supernatant. The final crystal concentration for the experiments is 2×107 crystals/mL in P3083 and 2×109 crystals/mL in P4502. For the mixing experiments, a highly concentrated solution of NADH at 300 mM is freshly prepared by weighing the coenzyme powder and mixing it with the corresponding crystallization buffer at 18% PEG 3350.

### Diffraction Experiments

In some embodiments, experiments are conducted at the SPB/SFX instrument of the European XFEL during granted proposals P3083 and P4502. During P3083, 202 pulses deliver at 10 Hz and 9.3 keV, with an approximate 3 μm spot size. An average pulse energy is 2.5 mJ with a duration of 40 fs separated by 1.77 μs, and diffraction data collects on the MEX instrument 115 (e.g., with an AGIPD detector) operating in fixed medium gain mode. During experiment 4502, 202 pulses spaced by 1.77 μs, deliver at 10 Hz and 7 keV with a ˜3.5 μm spot size. An average pulse energy is 1.8 mJ with a duration of 40 fs, and diffraction data collects operating in fixed medium gain mode. During both experiments, live hit detection is monitored on the control hardware 110 (e.g., via OnDA).

### X-Ray Diffraction Data Processing and Structure Determination

For structure determination, the control hardware 110 identifies hits (e.g., by the Cheetah software) after applying gain calibration. In some embodiments, a crystal hit is defined to satisfy the following criteria: using Peakfinder 8, an ADC threshold of 150, a minimum SNR of 6, and a minimum of 1 pixel per peak to identify a minimum of 10 peaks in a resolution range of 0-500 (pixels) is applied. Additionally, to correlate hits on waterfall plots with droplets for synchronization, the control hardware 110 (e.g., via a Python script) detects instances where the hits-per-train value was non-zero. The control hardware 110 overlays the correlation with the droplet signal for each train, generating a waterfall plot.

In some embodiments, the control hardware 110 indexes hits with CrystFEL v0.10.2. In some embodiments, the control hardware 110 performs an additional round of peak finding with Peakfinder 8 using more robust parameters (e.g., ADC threshold of 250, a minimum SNR of 4, and a minimum of 2 pixels per peak needed to identify a minimum of 10 peaks in a resolution range of 10-800 pixels) and supplies the peaks to indexing attempts using the algorithms Mosflm, XDS, DirAx and XGANDALF. In some embodiments, intensities are integrated applying radii of 2, 4, and 6 and merge into pointgroup mmm using the CrystFEL program partialator, applying 1 iteration of a unity model.

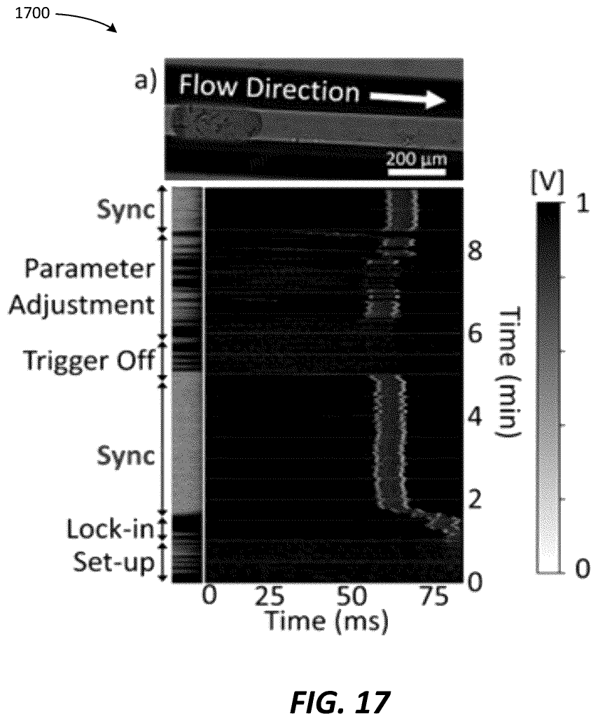

FIG. 17 is an image 1700 illustrating a crystal droplet from the MDI 105 and a corresponding waterfall plot, according to some embodiments. The image 1700 illustrates the waterfall plot according to the above procedures conducted during P4502. In the image 1700, the green triangles on the left of FIG. 17 indicate crystal hits.

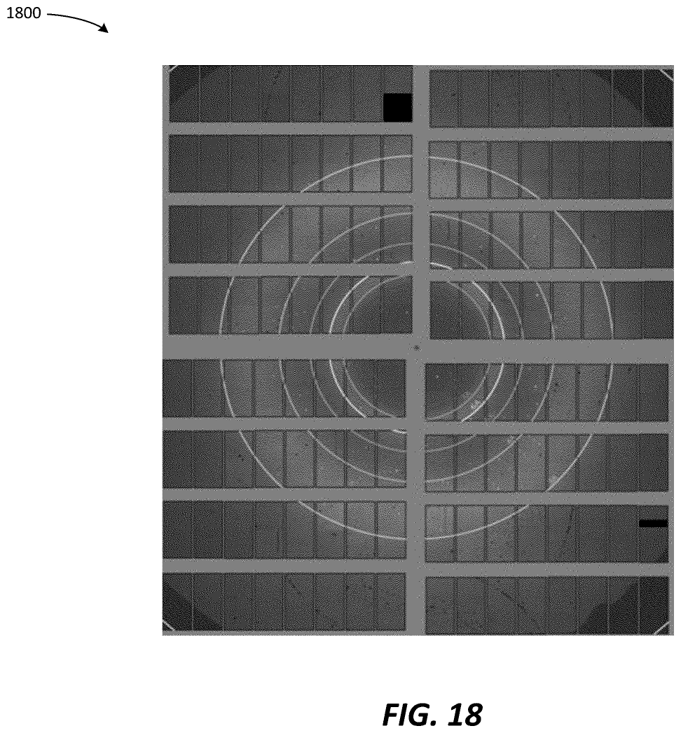

A representative diffraction pattern for the complex NQO1-NADH is shown in FIG. 18. FIG. 18 is an image 1800 illustrating a representative diffraction pattern of an NQO1-NADH structure for a 1190 ms time point using the MDI 105, according to some embodiments. Data collection and refinement statistics are listed in Table 3. During beamtime P3083, the MFX instrument 115 collects two data sets, one for the free NQO1 and one for NQO1 mixed with NADH at a 300 ms reaction time point. For beamtime P4502, the MFX instrument 115 collects two more data sets, one for the free NQO1 and one for the NQO1 mixed with NADH at the 1190 ms time point. Table 4 includes an overview of the data collected for both beamtimes.

TABLE 3
Data Collection and Refinement Statistics
(values for outer shell in parentheses).

| | | | |
|---|---|---|---|
| Free | | NQO1- | NQO1- |
| NQ01 | Free NQO1 | NADH | NADH |
| (P3083) | (P4502) | (305 ms) | (1100 ms) |

Data collection statistics

| | | | | |
|---|---|---|---|---|
| Data collection | 66.5 | 191.5 | 38 | 85.5 |
| time (min) | | | | |
| Wavelength (Å) | 1.3332 | 1.7712 | 1.3332 | 1.7712 |
| Detector | AGIPD 1 | AGIPD 1 | AGIPD 1 | AGIPD 1 |
| | Mpx | Mpx | Mpx | Mpx |
| Space group | P2₁2₁2₁ | P2₁2₁2₁ | P2₁2₁2₁ | P2₁2₁2₁ |
| a, b, c (Å) | 61.6, | 61.5, | 61.6, | 61.5, |
| | 107.6, | 107.8, | 107.7, | 107.8, |
| | 198.6 | 198.1 | 198.6 | 198.1 |
| α, β, γ (°) | 90, 90, 90 | 90, 90, 90 | 90, 90, 90 | 90, 90, 90 |
| Resolution range | 27.0-2.5 | 26.7-2.30 | 25.6-2.5 | 26.4-2.5 |
| (Å) | (2.56- | (2.38-2.30) | (2.57- | (2.59-2.50) |
| | 2.50) | | 2.51) | |
| Completeness | 100 (100) | 100 (100) | 100 (100) | 100 (100) |
| (%) | | | | |
| CC* (%) | 98.55 | 98.59 (71.56) | 98.72 | 97.86 |
| | (89.13) | | (82.0) | (54.64) |
| CC_{1/2} (%) | 94.39 | 94.55 (34.41) | 95.06 | 91.86 |
| | (65.88) | | (50.64) | (17.5) |
| Multiplicity | 489 (347) | 237 (142) | 287 (204) | 115 (84) |
| Rₛₚₗᵢₜ | 20.4 | 22.5 (126.8) | 22.0 | 28.5 |
| | (69.5) | | (127.1) | (189.8) |
| Avg. I/σ (l) | 4.3 (1.2) | 3.5 (0.6) | 3.7 (0.7) | 2.8 (0.5) |

Refinement Statistics

| | | | | |
|---|---|---|---|---|
| Resolution range | 27.0-2.5 | 26.7-2-30 | 25.6-2.5 | 26.4-2.5 |
| (Å) | (2.56- | (2.36-2.30) | (2.57- | (2.56-2.50) |
| | 2.50) | | 2.51) | |
| No. of | 44,040 | 56,465 | 42,064 | 43,444 |
| reflections, | | | | |
| working set | | | | |
| No. of | 2,350 | 2,939 | 2,176 | 2,326 |
| reflections, test | | | | |
| set | | | | |
| R_{work}/R_{free} (%) | 23.7/19.4 | 20.0/24.9 | 20.6/25.5 | 19.9/24.4 |

No. of non-H atoms

| | | | | |
|---|---|---|---|---|
| Protein | 8606 | 8764 | 8725 | 8691 |
| Water | 279 | 579 | 224 | 247 |
| FAD/NADH | 208/0 | 208/0 | 208/86 | 208/86 |
| Others | 0 | 4 | 0 | 0 |

R.m.s. deviations

| | | | | |
|---|---|---|---|---|
| Bond length (Å) | 0.006 | 0.006 | 0.005 | 0.006 |
| Bond angles (°) | 0.001 | 0.001 | 0.001 | 0.001 |
| Average B factors | 46.99 | 41.10 | 56.23 | 28.11 |
| (Å²) | | | | |

Ramachandran plot

| | | | | |
|---|---|---|---|---|
| Favored (%) | 97 | 98 | 98 | 97 |
| Allowed (%) | 3 | 2 | 2 | 3 |
| Outliers (%) | 0 | 0 | 0 | 0 |
| PDB code | 9EZQ | 9EZS | 9EZR | 9EZT |

TABLE 4
Data Acquisition During P3083 and P4502.

| | | | | Indexed | |
|---|---|---|---|---|---|
| Beamtime | Dataset | Frames | Hits | Patterns | Lattices |
| P3083 | Free NQO1 | 8,411,372 | 44,508 | 35,329 | 38,226 |
| | 305 ms | 4,422,184 | 24,631 | 18,794 | 19,815 |
| P4502 | Free NQO1 | 14,656,518 | 40,168 | 28,877 | 34,367 |
| | 1190 ms | 9,490,617 | 15,268 | 10,992 | 12,903 |

In some embodiments, the control hardware 110 generates MTZ files for phasing and refinement by the CTRUNCATE program from the CCP4 software package and includes a fraction of 5% reflections in the generated Rfree set. The control hardware 110 obtains initial phases of free NQO1 and NQO1 in complex with NADH by molecular replacement with MOLREP. For the free NQO1 structures, the SFX structure (e.g., PDB 8C9J) is the search model. In the case of the dynamic structures, the free NQO1 structures described above are the search model. The control hardware 110 refines the obtained models using alternate cycles of automated refinement using non-crystallographic symmetry (NCS) with REFMAC5 and performs manual inspection with COOT. In some embodiments, the control hardware 110 validates the final refined structures using the Protein Data Bank (PDB) validation service prior to deposition. The atomic coordinates and structure factors are deposited in the PDB with accession codes PDBs 9EZQ and 9EZS for the free NQO1, and 9EZR and 9EZT for NQO1 in complex with NADH at 300 ms and 1190 ms, respectively. In some embodiments, the control hardware 110 calculates electron-density and POLDER maps with the MAPS tool in the PHENIX software suite. In some embodiments, structure figures are generated with PYMOL (version 2.4.0) (e.g., from Schrödinger LLC).

### Results and Discussion

The MDI 105 synchronizes droplets for a segmented droplet injection approach for TR-SFX at the EuXFEL. As shown, the MDI 105 includes with the upstream mixer (e.g., in either the sample reservoir 175 or the combination of the protein crystal channel 1105 and the substrate channel 1110 at the sample channel 160) to implement time-resolved crystallography with the mix-and-inject principle relative to the reaction of NQO1 and its coenzyme NADH.

Droplet Generation with Capillary Coupled Device at SPB/SFX

The control hardware 110 includes both the hardware and software elements for implementation of the feedback mechanism (e.g., using the droplet detector 125) to regulate droplet synchronization with X-ray pulses. In contrast to the 120 Hz XFEL repetition rate at LCLS, the EuXFEL operates on a distinctive pulse structure characterized by the delivery of a train of X-ray pulses at MHz repetition rate generated every 100 ms. Within the train, 202 X-ray pulses are separated by roughly 1.8 us in the present experiments. Given this pulse structure, the MDI 105 diverges from introducing a droplet for each pulse; instead, the MDI 105 introduces one droplet for every pulse train. As such, the sample droplet spans the approximately 358 us long train duration considering apparent jet velocities and droplet volumes. Previously, characterization of 3D-printed GDVNs with a 100 μm orifice show that jet velocities of approximately 25 m/s arise with the aqueous flow rates shown above (18-22 μL/min) corresponding to gas mass flow rates of ˜20 mg/min. As such, the distance traveled by a given sample volume in 358 us is about 5 mm. A typical GDVN jet made by a 3D printed nozzle is 3-10 μm in diameter. For a rod-like droplet shape during jetting with a radius of 5 μm (e.g., the droplet is reduced in width from the 100 μm from the GDVN liquid orifice to ˜5 μm in the jet), a minimum of 706 pL droplet volume will span the time the pulses are fired within a train, as shown in FIG. 15. As described in further detail below, the droplet volumes generated with the MDI 105 span the entire pulse train.

For the MDI 105 during the P3083 beam time at the SPB/SFX instrument in a mix-and-inject experiment, the MDI 105 couples to the protein crystal channel 1105 and the substrate channel 1110 to mix the NQO1 crystals with the substrate NADH, as shown in FIG. 15. The MDI 105 mixes together the protein crystals and the substrate solution just before droplet generation within the droplet generator 120. Thus, the MDI 105 implements time-resolved serial crystallography while also conserving the sample through droplet generation at the droplet generator 120.

Reaction time points in the two experiments are influenced by the flow rates used to propel the solutions into the XFEL pulse path. To assess the reaction time point for a specific run, the control hardware 110 estimates an average velocity within the oil channel 155 from volumetric flow rates during the experiment and the length and cross-section of the protein crystal channel 1105, the substrate channel 1110, and the oil channel 155. As illustrated in the embodiment of FIG. 15, three discrete sections (A-C) are defined as described above, where changes in flow rate and channel cross-section may occur. The three discrete sections include section A, the length of the sample channel 160 where the substrate initially encounters the protein crystal suspension with length a=528 μm, section B, the length of the oil channel 155 where the droplet is formed and accelerated by the oil solution with length b=285 μm, and section C, the length of the MDI 105 before the droplet undergoes acceleration by the sheathing gas within the nozzle 130 with length c=2 cm.

In a first example of a TR experiment, the first example includes an MDI 105 including a width, w, of 100 μm in section A and w of 150 μm in section B. The MDI 105 of the first example generates 10 Hz droplets. The MDI 105 injects droplets at an average crystal flow rate (Q_X) of 4.9 μL/min, substrate flow rate (Q_S) of 5.0 μL/min, and oil flow rate (Q_O) of 18.2 μL/min for about 40 minutes. Without triggering but with droplet generation via the droplet generator 120, the flow rates correspond to a time point of about 305 ms. The sample flow rate during droplet injection was about a factor of 6 lower than the total flow rate (Q_T). Compared to continuous sample injection with a GDVN at the same Q_T, approximately 83% less crystal sample is injected, resulting in the NQO1 structure at 305 ms.

### Droplet Generator Improvements

Since the MDI 105 injects 10 Hz droplets that matches the X-ray pulse pattern of the EuXFEL, some factors may influence the droplet generation in the droplet generator 120. For example, SEM imaging may be conducted to examine the dimensions of the droplet generator 120, more specifically the wall thickness and shape of a barrier separating the plurality of electrode wires 150 from the oil channel 155 where droplet generation occurs at the intersection point 805. FIG. 16 (at image 1605) illustrates a deformation of the 5 μm thick wall that may influence the electrical trigger at the intersection point 805. In some embodiments, the wall thickness is doubled to 10 μm. SEM imaging confirms that the barrier thickness of 10 μm eliminates the deformation (FIG. 16 at image 1610).

In some embodiments, protein crystal channel 1105 and substrate channel 1110 (and the sample channel 160) having a width of 150 μm matches the dimensions of the oil channel 155, as shown in FIG. 16. Modifying the channel geometry at the intersection point 805 alters the capillary number, influencing fluid interactions at the intersection point 805 between dripping and squeezing.

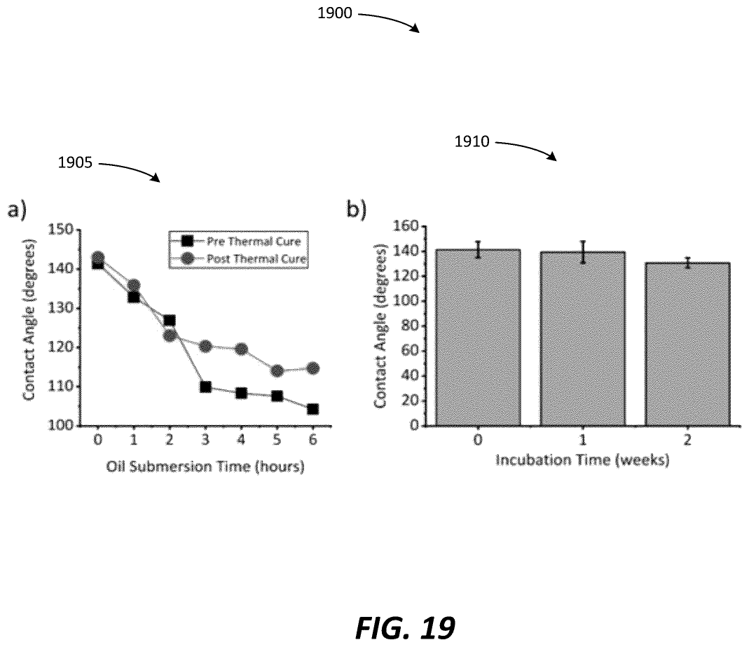

FIG. 19 illustrates a contact angle characterization 1900 for a boundary created between oil, water, and 3D-printed substrate using the MDI 105, according to some embodiments. In some embodiments, coating the resin surfaces overnight with NOVEC 1720 (e.g., from 3M, St. Paul, USA) followed by thermal curing at 65° C., increases the longevity of the surface treatment when the surface is in contact with the oil solution. Additionally, the surfaces remain stable for several weeks after the treatment and curing when stored in air. The contact angle characterization 1900 includes a graph 1905 that illustrates a decay of the contact angle on a 3D printed surface over a period of up to 6 hours of submersion in oil emulating the conditions of use for the MDI 105 when transporting segmented droplets. When the surface treatment is not thermally cured, the decay in contact angle is more pronounced and shows a steeper decline compared to the surfaces that are thermally cured. Thus, the longevity of the surface treatment is prolonged due to thermal curing and within the droplet generator 120, the extension in the lifetime of the surface treatment increases sustained functionality throughout an operational shift.

Additionally, because the preparation of an SFX beamtime requires the fabrication of the droplet generator 120 a few weeks in advance, performing a longevity study of the surface treatment may be important, as shown in an image 1910 of FIG. 19. The sustained contact angle on the thermally cured surfaces confirms that the components of the MDI 105 remain hydrophobic up to two weeks after initial surface treatment.

As illustrated in the waterfall plot 1625 of FIG. 16, droplets generated using the oil solution and NQO1 buffer at 10 Hz and show long-term stability for over 2 hours. The MDI 105 also shows sufficient response to triggering, as illustrated by the rapid change in droplet phase while maintaining lock-in along the waterfall plot 1630 of FIG. 16. Furthermore, the MDI 105 generates droplets that are approx. 2.3 nL in volume, as shown in the image 1700, well above the approximate 700 pL to cover the entire MHz train.

TR-SFX with DG300-Y-Mixers

As another example, the MDI 105 is implemented with experiment P4502 at the EuXFEL to conduct time-resolved crystallography on NQO1. The control hardware 110 controls the MDI 105 to generate droplets at 10 Hz and to synchronize the droplets generated at that frequency with the EuXFEL pulse trains. The droplet generator 120 follows a similar start-up procedure, in which substrate, crystal sample, and oil flow rates increase beyond the target to initiate faster delivery of solutions. After a stabilization phase of approximately 10-15 minutes, the droplet generation frequency reaches close to the target 10 Hz, and the electrical triggering system initiates via the control hardware 110.

FIG. 17 (at image 1700) shows the representative waterfall plot for droplet injection at 10 Hz. In the image 1700, the droplet detector trace is divided into 100 ms sections according to the XFEL-reference pulse at 10 Hz and each trace is aligned in a vertical stack with the color representing the amplitude of the signal. As the flow rates stabilizes at Q_X=1.00 L/min, Q_S=0.75 μL/min, and Q_O=18.5 μL/min, the droplet generator 120 generates droplets near the 10 Hz target frequency. The control hardware 110 initiates the trigger with a duration of 4 ms, a delay of 70 ms, and an amplitude of 180 V. Droplets stabilize just before 2 minutes maintaining stability for approximately 3 minutes without any system disturbance. Green triangles on the left of the image 1700, indicating crystal hits, confirm synchronization with the EuXFEL pulse structure for the 3 minutes, with 1631 diffraction patterns recorded at a hit-rate of 0.4%.

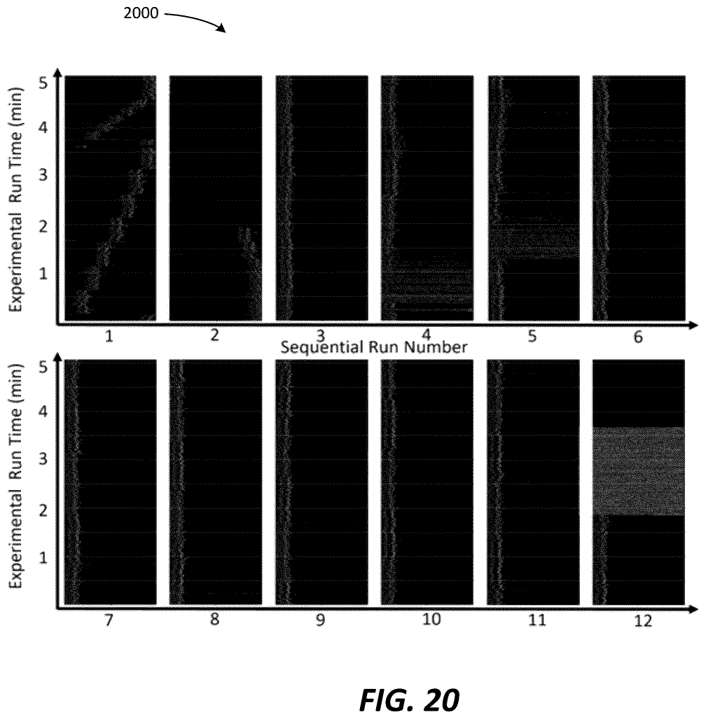

Following this stack of synchronized droplets, the control hardware 110 turns off the trigger after 5 minutes, causing the droplets to immediately fluctuate in frequency and phase. A minute later, the control hardware 110 turns the trigger back on with the same duration and delay, but with a reduced amplitude of 40 V. Although the droplet signal locked-in about 30 seconds later, the droplet signal does not remain stable, indicating that the reduced amplitude does not stabilize the droplet-generation frequency lock-in. Similarly, at approximately 7.5 minutes, the amplitude increases to 110 V, showing more frequent but still unstable lock-ins. At approximately 8.5 minutes, the amplitude increases back to 180 V showing the droplets immediately lock-in and synchronize as shown initially. The second instance of synchronization demonstrates the reproducibility of the synchronization process of the MDI 105 once droplets generate at 10 Hz with the appropriate triggering conditions are applied. FIG. 20 illustrates a graph 2000 showing a waterfall plot during droplet delivery of mixed NQO1 crystals with the MDI 105, according to some embodiments. As illustrated in FIG. 20, the MDI 105 generates 10 Hz droplets through electrical triggering for durations of up to one hour as indicated through waterfall plots of 12 consecutive runs of FIG. 20. The graph 2000 shows the synchronization of the triggered droplet injection approach at 10 Hz at the SPB/SFX instrument.

The MDI 105 includes three sections as previously illustrated: section A, where the substrate and crystal stream first meet and mixing is initiated by diffusion in the convective flow, section B, where the droplet is formed and additional mixing may occur in the developing droplet, and section C, the path of the droplet through the MDI 105 prior to injection by the nozzle 130. A sum of the three sections and corresponding flow rates determines an average time point of the reaction probed between NQO1 and NADH, t_{R}, shown in Equation 1:

$${t}_{R} = {t}_{A} + {t}_{B} + {t}_{C} \qquad Equation 1$$

where t_{A} is the time point of section A, t_{B} is the time point of section B, and t_{C} is the time point of section C.

In an example for the MDI 105, the flow rates of Q_X=4.9 μL/min and Q_S=5.0 μL/min, are used. Based on the device geometry and flow rates, the sample spends an average time, t_{A}, of 32 ms in section A. Once the droplet is formed at the intersection point 805, with Q_O of 18.2 μL/min, the total flow rate Q_T amounted to 28.1 μL/min leading to t_{B} and t_{C} of 14 ms and 259 ms, respectively, and t_{R} of 305 ms.

In another example for the MDI 105, which operates at lower aqueous flow rates to generate 10 Hz droplets, the longer residence time in section A resulted in t_{R} of 1190 ms before irradiation with the XFEL pulses. Q_X=0.5 μL/min, Q_S=0.4 μL/min, and Q_O=18.3 μL/min resulted in t_{A}, t_{B}, and t_{C} as summarized in Table 5.

TABLE 5
Average Residence Times for Solutions in
Droplet Generators.

| Droplet | t_{A} | t_{B} | t_{C} | t_{R} |
|---|---|---|---|---|
| Generator | (ms) | (ms) | (ms) | (ms) |
| DG250-Y-Mixer | 32 | 14 | 259 | 305 |
| (First Example) | | | | |
| DG300-Y-Mixer | 792 | 20 | 378 | 1190 |
| (Second Example) | | | | |

In some examples, the spread of t_{R} is caused by the diffusion-based mixing in section A and the mixing occurring in the droplet once formed in section B. Once incorporated in droplets, crystals are transported at the same velocity, thus the time variation in section C is negligible. To quantitatively determine the spread of t_{R} due to the different mixing regimes, the beginning of the reaction is assumed to occur when the concentration of the protein in the crystal and the substrate concentration are equivalent. Furthermore, to estimate the mixing rate of the substrate into the crystal stream, a convection-diffusion model using finite element modeling may be used. The control hardware 110 uses a 2D-model that includes a channel section corresponding to section A, flow rates for the experiments with the two time points, and with a reported diffusion coefficient for NADH of 6.7*10⁻⁶ cm²s⁻¹ as described above and shown in Table 2.

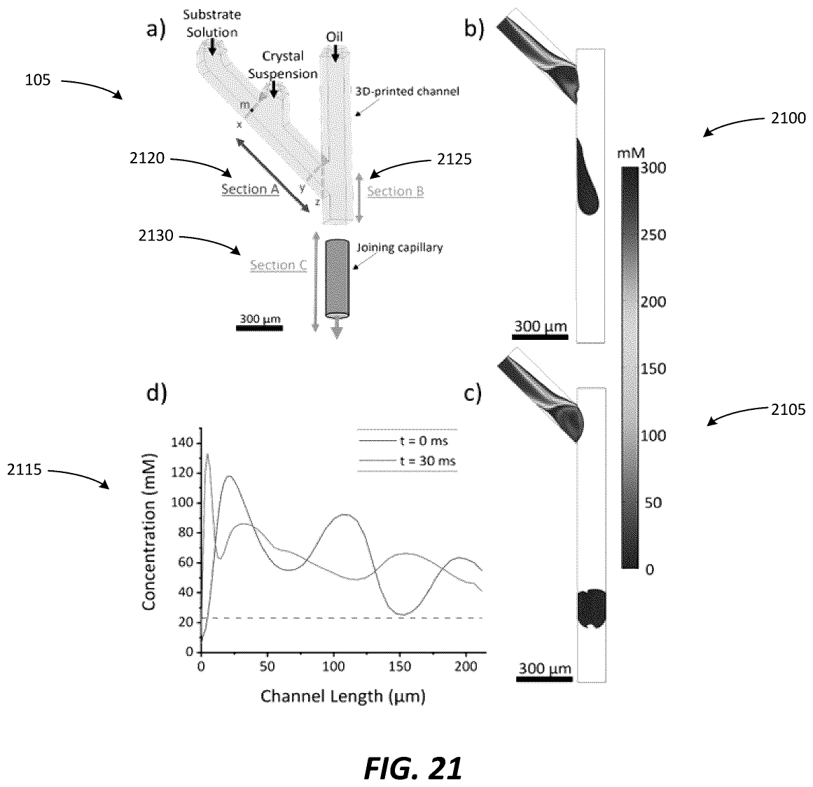

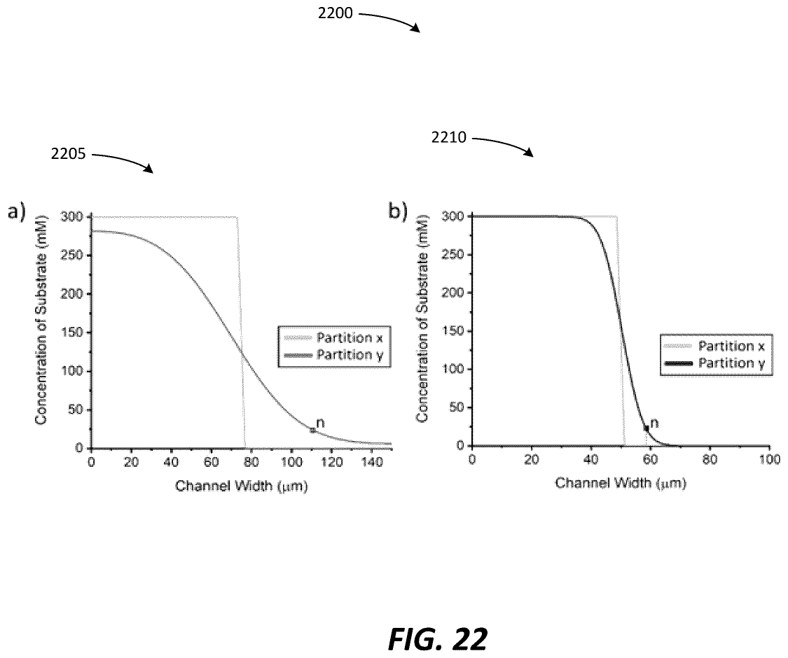

In some embodiments, the concentration distribution from the convection at the flow rates and diffusion of NADH may be evaluated at two different positions within section A; at a partition x (where protein crystal channel 1105 and the substrate channel 1110 meet) and at a partition y (at the end of the sample channel 160, just before the droplet is formed), as shown in FIG. 21. FIG. 21 illustrates a schematic representation of the MDI 105 divided into partitions and corresponding droplet computational models, according to some embodiments. At the different partitions, a projection of the concentration profiles is shown in FIG. 22 for different examples of the MDI 105, where a point n corresponds to a point at which the substrate concentration and the protein concentration in the crystal are equimolar, and where the reaction initiates.

Where the two solutions (crystal and substrate) first meet in the center of the channel in section A (e.g., a section 2120 of FIG. 21 at a point m) shows the earliest instance at which the reaction can initiate, representing the longest reaction time. Due to a parabolic flow profile, the mixing of the substrate with crystals is not homogeneous so the crystals closer to the channel wall flow at a lower velocity and, thus, mix with the substrate later. Therefore, both the slowest and fastest velocities of the aqueous flow and the difference in travel time contribute to the range in a calculated reaction time. From a graph 2205 of FIG. 22, the substrate concentration in the solution carrying the crystal sample at the end of section A had only reached a 1:1 mixing ratio 36 μm from the center of the sample channel 160 (or, correspondingly, 39 μm from the channel wall). The graph 2205 shows that only about 50% of the sample began to react and comparing the linear flow velocity at this position with that in the center of the channel, shows a 55.4 ms difference for the fastest and slowest flow velocity in the sample channel 160 in which the substrate concentrations are large enough to initiate binding.

From a graph 2210 of FIG. 22, since the solutions flow faster within section A, the substrate reaches an equivalent concentration to the crystal solution about 8 μm from the center of the channel at the end of section A at point n. From to the lowered residence time in section A (e.g., the section 2120), about 85% of the solution within the sample channel 160 remains unmixed before the droplets are generated at the intersection point 805. As such, the mixing time variation shows 0.15 ms based on the difference between the fastest and slowest flow velocity in the sample channel 160 in which the substrate concentrations are large enough to initiate binding.

In section B (e.g., a section 2125 of FIG. 21), the sample solution (e.g., the substrate and the protein crystals) enters the oil channel 155 forming droplets embedded in the oil solution that induce a spontaneous circulation mixing effect that increases mixing. To simulate the mixing process, the generation of the droplets in the oil channel 155 is shown with a 2D model of the geometry of the droplet generator 120. A laminar two-phase flow model includes a level set interface method combines with the transport of diluted species module to simulate the droplet generation and the diffusion of the substrate molecules. The two phases of the flow model include the oil solution and NQO1 mother liquor (FIG. 21 and Table 2). At section C (e.g., a section 2130 of FIG. 21), the segmented droplets embedded in the oil solution flow through the MDI 105 after the intersection point 805.

A first flow image 2100 and a second flow image 2105 are shown for the time-dependent model in FIG. 21 for an embodiment of the MDI 105 (e.g., at a 1190 ms time point). The first flow image 2100 corresponds to a frame after a droplet breaks off the intersection point 805. FIG. 21 also includes a graph 2115 illustrating a concentration distribution along a line (e.g., a line z of FIG. 21) separating the sample channel 160 and the oil channel 155 indicating that mixing occurs, as the substrate concentration surmounts 23 millimolar (mM). The substrate concentration of 23 mM concentration corresponds to a 1:1 mixture of protein crystals to substrate based on an estimated concentration of NQO1 in the crystal. The flow profile based on the differences in flow rates in the two phases illustrate an additional mixing effect (e.g., shown from the concentration distribution at the intersection point 805 in the first flow image 2100), which increases the substrate concentration to a concentration greater than 23 mM at the intersection point 805 where the droplet is generated. The second flow image 2105 (e.g., showing 30 ms after a start of droplet generation), illustrates complete mixing, which is also illustrated by the concentration profile in the graph 2115. Accordingly, in some embodiments, mixing in the droplets is instantaneous, and no further spread in the mixing time is introduced through droplet generation.

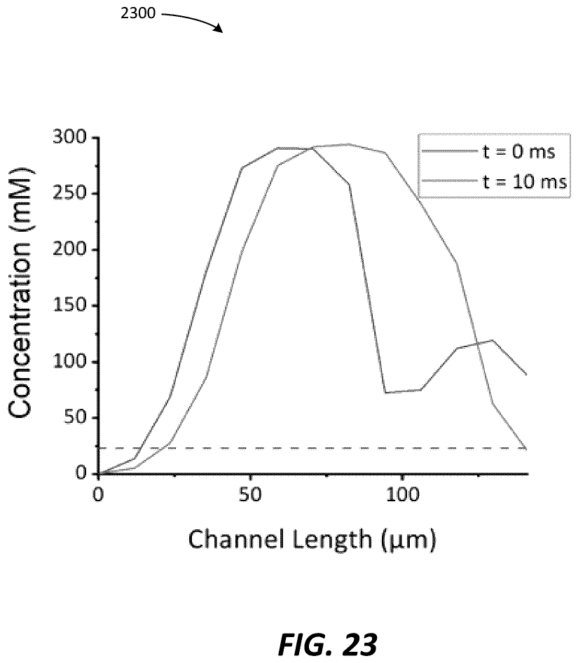

The same mixing characteristics may also be shown for a 300 ms time point in another embodiment of the MDI 105. FIG. 23 illustrates a graph 2300 showing a concentration of substrate along where a sample stream and an oil stream meet (e.g., the intersection point 805) within the MDI 105, according to some embodiments. The graph 2300 illustrates that time spread variation from droplet generation is negligible as the substrate concentration exceeds 23 mM. Thus, the total time spread of t_{R} for the second embodiment of the MDI 105 remains at 55 ms (e.g., based on contribution from section A) and at 0.15 ms for first embodiment of the MDI 105. In some embodiments, variations in mixing times may be compared with the diffusion of the substrate into the protein crystals. As an example, for shoe-box shaped crystals with dimension of 10×20×30 μm³, diffusion times are approximately 15 ms. Accounting for similar time scales, the time spread for both time-resolved experiments is less than 6% of the reaction time point for each case.

As such, the length of section A (e.g., the section 2120) may be a limitation for reactions at faster time points, specifically when the MDI 105 operates the droplet generator 120 at 10 Hz, where sample solution flow rates are low. In some embodiments, the droplet generator 120 mixes the protein crystals and the substrate shortly before the intersection point 805. By mixing the protein crystals and the substrate shortly before the intersection point 805, the droplet generator 120 minimizes overall reaction time and restricts the time spread introduced by diffusive mixing of the protein crystals and the substrate. For example, in the MDI 105 with channel dimensions similar to those of the second embodiment of the MDI 105, but where the length of section A (e.g., the section 2120) is reduced from 528 μm to 100 μm, the time spread is reduced to 11 ms.

### Sample Consumption

In some embodiments, for the 305 ms time point and the 1190 ms time point, sample consumption of the MDI 105 during droplet injection is shown in Table 6. While the MDI 105 sustains droplet generation via the droplet generator 120 throughout the experiment at the EuXFEL for several hours, the data of Table 2 only includes runs where the control hardware 110 optimizes droplet generation via the droplet generator 120 for diffraction collection for the two time points.

TABLE 6
Time points analyzed and sample consumption during P3083 and P4502.

| | Data | | | Protein | Protein | |
|---|---|---|---|---|---|---|
| t_{R} | Collection | Indexed | | Concentration | Consumption | Resolution |
| (ms) | Time (min) | patterns | Patterns/μL | (mg/mL) | (mg) | (Å) |
| 305 | 36.5 | 24,631 | 132 | 18 | 3.2 | 2.7 |
| 1190 | 130 | 15,268 | 357 | 25.5 | 1.7 | 2.5 |

In some embodiments, for the 305 ms time point, the MDI 105 consumes 3.2 mg of protein sample which is less than that from continuous injection with a GDVN, which consumes approximately 18.5 mg at the same total flow rate and time. The MDI 105 has nearly 6-fold sample savings despite the lack of droplet synchronization. At the 10 Hz frequency with the second embodiment of the MDI 105, droplet injection records for about 2 hours, including over 15,000 patterns and 235 patterns per μL of sample injected. The sample injection is approximately 3 times more efficient than for the 305 ms time point. Furthermore, for the 10 Hz scenario where the longer time point (e.g., 1190 ms) in the reaction of NQO1 with NADH, more than 60 mg of protein would have been consumed if a continuous GDVN were used with a similar flow rate. Thus, the MDI 105 conserves approximately 97% of the sample solution in comparison to a continuous injection GDVN.

Structural and Dynamics Insights into the Reductive Half-Reaction of NQO1 with NADH

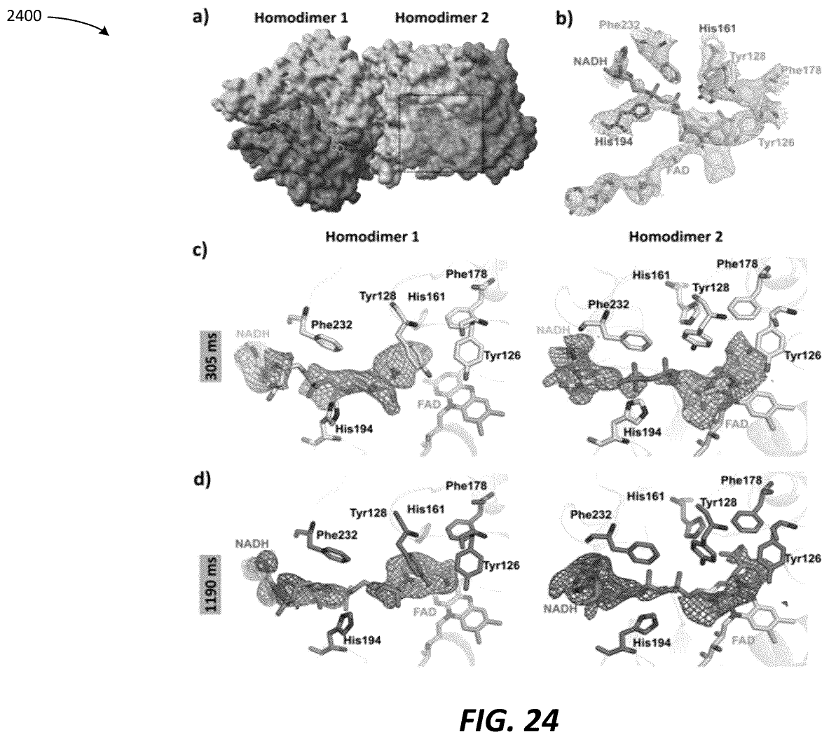

Efficient reaction initiation in crystals includes fast incorporation of ligands to active sites. In a proof-of-principle example, NQO1 microcrystals are suitable for time-resolved experiments through binding of the coenzyme NADH with a crystal slurry of NQO1 after incubating for 1 hour before analysis. For molecular determinants of the catalytic mechanism of NQO1, time-resolved SFX data of the reductive half-reaction of NQO1 with NADH is illustrated at two mixing time points (e.g., 305 and 1190 ms FIG. 24). For comparison, the crystal structures of NQO1 is also shown in NQO1's free form.

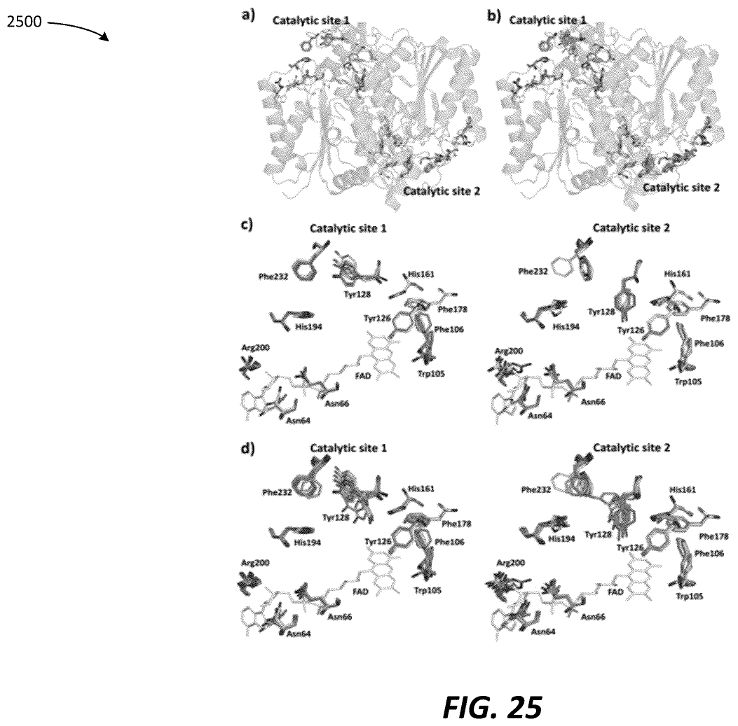

FIG. 24 is an image 2400 illustrating time-resolved structures of NQO1 with NADH at 305 ms and 1190 ms using the MDI 105, according to some embodiments. NQO1 microcrystals belong to the space group P212121 with two homodimers in the asymmetric unit, as shown in FIG. 24 at part a, related by a non-crystallographic two-fold axis of symmetry with a typical folding characteristic. All data collection, processing, and refinement parameters and statistics are shown in Table 3. In some embodiments, NQO1 includes a high conformation heterogeneity in the two catalytic sites of NQO1 that agrees with the negative cooperative. To see whether the high conformation heterogeneity is in the free form NQO1 structures, FIG. 24 includes a structural comparison of the free form NQO1 structures from P3083 and P4502 experiments with each other and with other free form NQO1 structures at room temperature by serial crystallography. FIG. 25 is an image 2500 illustrating structural comparison of free form NQO1 structures, according to some embodiments. As illustrated in FIG. 25, residues at the catalytic site show a high flexibility. Among the highest flexibility is shown for residues Asn64, Gln66, Tyr126, Arg200 and Asn233, the most relevant for Tyr128 and Phe232, which, for some of the homodimers, are shown in various conformations. The Tyr126 and Tyr128 residues, that gate the catalytic pocket of NQO1, are strictly conserved and are shown to be the key players in the function of NQO1.

For the structure of NQO1 with NADH at t_{R}=1 hour, no significant difference in the unit cell dimensions between the free form and mixed proteins is shown in FIG. 25. In some embodiments, the reduction in plasticity of NQO1 shown upon binding of NADH takes longer than the time points illustrated. FIGS. 24 and 25 illustrate, besides the presence of FADs, many water molecules (Table 3). FIG. 24 illustrates a quality of the NQO1 structure that is shown from the 2mFo-DFc electron density maps shown for the catalytic site residues and the cofactor FAD (FIG. 24 at part b). The free form NQO1 structures versus those with NADH bound are shown by comparing crystal structures at room temperature (e.g., PDB entries 8C9J and 8RFN for the free form NQO1 and PDB entry 8RFN for the NQO1 in complex with NADH). Overall, the NQO1 structures include average root-mean-square deviation (RMSD) values of 0.294 Å for the Ca atoms. The global RMSD of 0.590 Å may illustrate slightly higher structural differences when a whole protein molecule is considered, mainly due to mismatch from flexible loops and solvent-exposed regions as expected.

The image 2400 of FIG. 24 also shows a surface representation of the two homodimers of NQO1 found in the asymmetric unit, at point a. The individual monomers are highlighted in light green (chain A), dark green (chain B), light pink (chain C), and purple (chain D). The NADH molecules bound to chain B and chain D, are represented as sticks in yellow and golden, respectively. The cofactor FADs are shown as pink sticks. The image 2400 also includes the electron density maps 2mFo-DFc at point b, contoured at 1 σ and stick representation of the FAD, NAD, and the residues in the catalytic site highlighted for the dash boxed panel in point a. The image 2400 also includes POLDER maps contoured at 3 σ of the NADH molecule bound to homodimer 1 (left) and homodimer 2 (right) at 305 ms time point for point c and POLDER maps contoured at 3 σ of the NAD molecule bound to homodimer 1 (left) and homodimer 2 (right) at 1190 ms time point for point d.

The image 2500 of FIG. 25 also shows superposition of the two homodimers of the free form NQO1 structures reported in this study (P3083 (homodimer 1 (magenta) and homodimer 2 (yellow) and P4502 (homodimer 1 (orange) and homodimer 2 (white)) at point a. For clarity, only one NQO1 homodimer is shown in FIG. 25 as a representation in dark grey and the residues and the FAD in the catalytic sites of all homodimers are shown as sticks. The image 2500 also includes a superposition of the two homodimers of the free NQO1 structures as shown in point a, and from other free form NQO1 structures using serial crystallography (homodimer 1 (green) and homodimer 2 (cyan) for PDB 8C9J; homodimer 1 (violet) and homodimer 2 (salmon) for PDB 8RFM, for point b. For clarity, only one NQO1 homodimer is shown in FIG. 25 as a representation in dark grey and the residues and the FAD in the catalytic sites of all homodimers are shown as sticks. The image 2500 also includes a view of the structural differences in the catalytic sites 1 and 2 shown in point a at point c. The image 2500 also includes a view of the structural differences in the catalytic sites 1 and 2 shown in point b at point d.

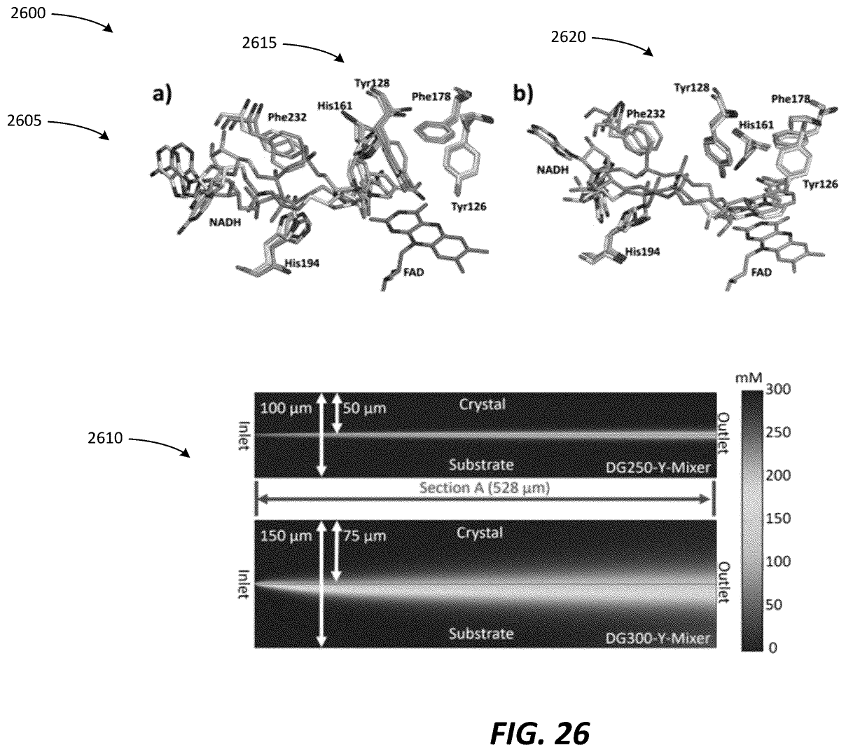

POLDER maps of the NADH molecules in the final model of the NQO1 in complex at 305 ms and 1190 ms are shown in FIG. 24 at points c and d, showing the lack of model bias and binding to the enzyme. Strong electron density is shown at 305 ms, indicating fast ligand binding even under a more viscous mother liquor condition and the large size of the NADH molecule. Ligand binding occurs within the millisecond time domain. At the 1190 ms time point, the intensity of the electron density does not change much compared to that of 305 ms. The sustained intensity of the electron density may be from the high flexibility of the NADH molecule at the catalytic site of NQO1. At both times (e.g., 305 ms and 1190 ms) in the reaction, the NADH molecules are not bound to the same homodimer, but one NADH molecule is bound to one active site of one of the homodimers and the other NADH molecule is bound to one of the active sites of the other homodimer in the asymmetric unit (FIG. 24 at point a). The NADH molecule binding illustrates the negative cooperativity. Furthermore, the exact disposition of both NADH molecules within each time point differs from one another and is also different from the position and orientation of the NADH molecule as previously shown for the static synchrotron structure of NQO1 with NADH (FIG. 26).

FIG. 26 illustrates an image 2600 including a structural comparison 2605 of catalytic sites and 2D channel dimensions 2610 for convection-diffusion simulation with the MDI 105, according to some embodiments. The structural comparison 2605 shows a stick representation 2615 of the catalytic sites of the homodimer 1 at 305 ms (yellow), 1190 ms (dark yellow), and t=infinite (cyan). The structural comparison 2605 also shows a stick representation 2610 of the catalytic sites of the homodimer 2 at 305 ms (yellow), 1190 ms (dark yellow), and t=infinite (cyan). The 2D channel dimensions 2610 show convection-diffusion simulation for the first embodiment of the MDI 105 (top) and the second embodiment of the MDI 105 (bottom). The substrate begins in a lower half of the sample channel 160 (red) and diffuses into the crystal stream (blue) at an upper half of the sample channel 160. A color gradient represents the concentration of substrate in mM.

Because NQO1 is involved in the detoxification processes within cells, particularly in the reduction of quinones, the negative cooperativity or binding inhomogeneity shown in NQO1, would allow NQO1 to efficiently handle varying concentrations of quinones within cells. When one quinone substrate molecule binds to the active site of NQO1, the quinone substrate molecule induces a conformational change in the NQO1 that reduces affinity for additional quinone substrate molecules. Overall, negative cooperativity in NQO1 may be relevant because the NQO1 may regulate activity in response to changes in substrate concentration, contributing to cellular detoxification processes and maintaining cellular homeostasis.

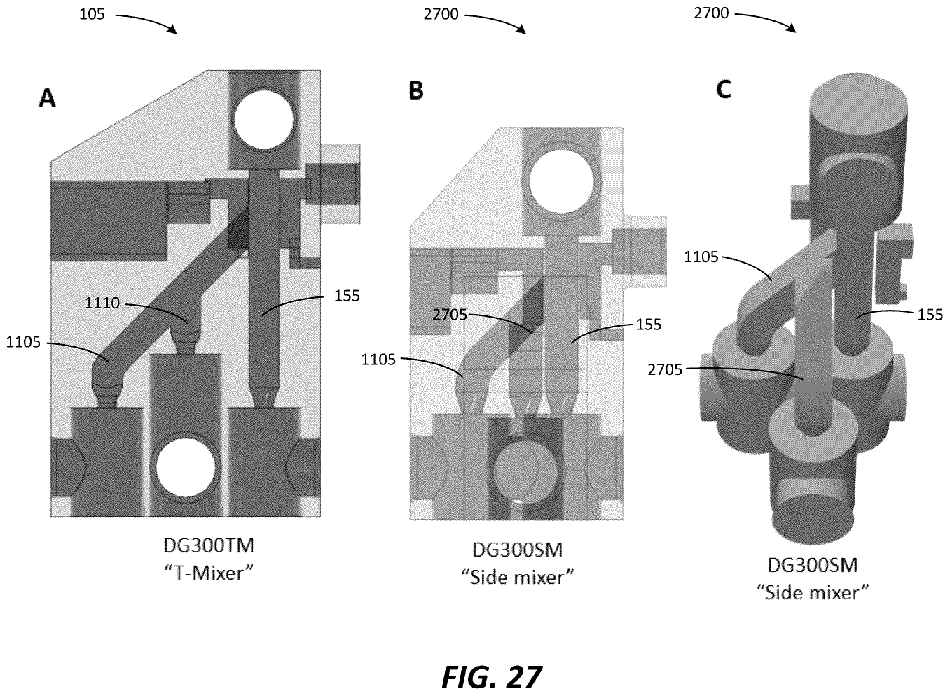

FIG. 27 illustrates the MDI 105 implemented with the MEX instrument 115, according to some embodiments. FIG. 27 also illustrates an alternative embodiment (an MDI 2700) of the MDI 105. It should be understood that the MDI 2700 includes similar components to the MDI 105. As such, the MDI 2700 is configured to operate in a similar manner to the MDI 105. For example, the MDI 2700 includes the oil channel 155 and the protein crystal channel 1105. The MDI 2700 also includes an offset substrate channel 2705. The offset substrate channel 2705 is offset to a side of the protein crystal channel 1105 and the oil channel 155. By positioning the offset substrate channel 2705 to the side of the protein crystal channel 1105 and the oil channel 155, the protein crystals from the protein crystal channel 1105 and the substrate from the offset substrate channel 2705 mix in the sample channel 160 closer to the intersection point 805. As such, the MDI 2700 may generate droplets at shorter time points in the reaction between the protein crystals and the substrate and reduce time spread during mixing.

As described herein, segmented droplet generation with the MDI 105 (or the MDI 2700) may be used with MISC TR-SFX at the SPB/SFX instrument at the EuXFEL. The embodiments described herein differ from drop-on-demand approaches, as a segmented stream of oil solution separated by aqueous crystal-laden droplets (e.g., the sample solution) are continuously injected and maintain all characteristics of liquid jet injection with nozzles (e.g., the nozzle 130) while compatible with MHz repetition rates. The embodiments described herein illustrate synchronization with the pulse trains of the EuXFEL repeating at 10 Hz and additionally couple the protein crystal channel 1105 and the substrate channel 1110 prior to droplet generation for the reaction of NQO1 with its substrate NADH at 305 ms and 1190 ms. With droplets generated at 10 Hz frequency, matching the pulse train repetition rate of the EuXFEL, embodiments described herein solve the structure of NQO1 with the substrate NADH bound at a resolution of 2.5 Å. Compared to a continuous injection with a GDVN at the same sample flow rate, 97% of the sample may be conserved.

Embodiments described herein illustrate TR-SFX for a 305 ms reaction time point. Although droplet generation may not be stable at a defined frequency, the described approach saves approximately 85% sample and may represent faster time points with minimal geometric changes in the droplet generator 120.

The embodiments described herein also illustrate structures of the NQO1 reaction with NADH in a TR-SFX experiment, indicating NADH binding to the NQO1 homodimer. The structural information illustrates insights into the catalytic function of NQO1.

Thus, the disclosure provides, among other things, a modular droplet injector for segmented droplet generation. Various features and advantages of the invention are set forth in the following claims.

What is claimed is:

1. A microfluidic droplet injector (MDI) for serial femtosecond crystallography (SFX), comprising:
a droplet generator including
an oil channel configured to supply an oil solution at a first flow rate;
a substrate channel configured to supply a substrate solution at a second flow rate;
a crystal channel configured to supply a crystal solution at the second flow rate;
a first intersection point of the substrate channel and the crystal channel to form a sample channel configured to supply a sample solution, the droplet generator configured to mix the substrate solution and the crystal solution at the first intersection point to initiate a reaction between the substrate solution and the crystal solution in the sample solution, the reaction including a first delay based on the second flow rate; and
a second intersection point of the oil channel and the sample channel, the droplet generator configured to generate a segmented droplet of the sample solution surrounded by the oil solution at the second intersection point based on the first flow rate and the second flow rate;
a droplet detector connected to the droplet generator, the droplet detector configured to
receive the segmented droplet of the sample solution surrounded by the oil solution from the droplet generator; and
detect a presence of the segmented droplet; and
a nozzle connected to the droplet detector, the nozzle configured to receive the segmented droplet of the sample solution surrounded by the oil solution from the droplet generator and jet the segmented droplet of the sample solution surrounded by the oil solution from the MDI for SFX, such that SFX occurs on the segmented droplet including the reaction at the first delay.

2. The MDI of claim 1, wherein the nozzle is a gas dynamic virtual nozzle.

3. The MDI of claim 1, wherein the nozzle is configured to:
jet the segmented droplet of the sample solution surrounded by the oil solution into an X-ray Free Electron Laser (XFEL) pulse for SFX.

4. The MDI of claim 3, wherein the droplet generator is configured to:
generate the segmented droplet of the sample solution surrounded by the oil solution based on a frequency of the XFEL pulse.

5. The MDI of claim 1, wherein an optimized size and configuration of the droplet generator, the droplet detector, and the nozzle use a 4-fold reduction in volume of the sample solution for output through the nozzle.

6. The MDI of claim 1, wherein the sample solution comprises protein crystals.

7. The MDI of claim 6, wherein the protein crystals are human NAD(P)H: Quinone oxidoreductase 1 (NQO1).

8. The MDI of claim 6, wherein the protein crystals are phycocyanin.

9. A microfluidic droplet injector (MDI) system comprising:
a microfluidic droplet injector (MDI) including
a droplet generator including
an oil channel configured to supply an oil solution at a first flow rate;
a substrate channel configured to supply a substrate solution at a second flow rate;
a crystal channel configured to supply a crystal solution at the second flow rate;
a first intersection point of the substrate channel and the crystal channel to form a sample channel configured to supply a sample solution, the droplet generator configured to mix the substrate solution and the crystal solution at the first intersection point to initiate a reaction between the substrate solution and the crystal solution in the sample solution, the reaction including a first delay based on the second flow rate; and
a second intersection point of the oil channel and the sample channel, the droplet generator configured to generate a segmented droplet of the sample solution surrounded by the oil solution at the second intersection point based on the first flow rate and the second flow rate;
a droplet detector connected to the droplet generator, the droplet detector configured to
receive the segmented droplet of the sample solution surrounded by the oil solution from the droplet generator; and
detect a presence of the segmented droplet; and
a nozzle connected to the droplet detector, the nozzle configured to receive the segmented droplet of the sample solution surrounded by the oil solution from the droplet generator and jet the segmented droplet of the sample solution surrounded by the oil solution from the MDI for SFX, such that SFX occurs on the segmented droplet including the reaction at the first delay.

10. The MDI system of claim 9, wherein the nozzle is a gas dynamic virtual nozzle.

11. The MDI system of claim 9, wherein the nozzle is configured to:
jet the segmented droplet of the sample solution surrounded by the oil solution into an X-ray Free Electron Laser (XFEL) pulse for SFX.

12. The MDI system of claim 11, wherein the droplet generator is configured to:
generate the segmented droplet of the sample solution surrounded by the oil solution based on a frequency of the XFEL pulse.

13. The MDI system of claim 9, wherein an optimized size and configuration of the droplet generator, the droplet detector, and the nozzle use a 4-fold reduction in volume of the sample solution for output through the nozzle.

14. The MDI system of claim 9, wherein the sample solution comprises protein crystals.

15. The MDI system of claim 14, wherein the protein crystals are human NAD(P)H: Quinone oxidoreductase 1 (NQO1).

16. The MDI system of claim 14, wherein the protein crystals are phycocyanin.

17. A droplet generator for a microfluidic droplet injector (MDI), comprising:
an oil channel configured to supply an oil solution at a first flow rate;
a substrate channel configured to supply a substrate solution at a second flow rate;
a crystal channel configured to supply a crystal solution at the second flow rate;
a first intersection point of the substrate channel and the crystal channel to form a sample channel configured to supply a sample solution, the droplet generator configured to mix the substrate solution and the crystal solution at the first intersection point to initiate a reaction between the substrate solution and the crystal solution in the sample solution, the reaction including a first delay based on the second flow rate; and
a second intersection point of the oil channel and the sample channel, the droplet generator configured to generate a segmented droplet of the sample solution surrounded by the oil solution at the second intersection point based on the first flow rate and the second flow rate and the segmented droplet having the reaction at the first delay.

18. The droplet generator of claim 17, wherein the droplet generator is configured to generate a continuous stream including a plurality of segmented droplets.

19. The droplet generator of claim 18, wherein each of the plurality of segmented droplets is surrounded by the oil solution in the continuous stream.

20. The droplet generator of claim 17, wherein the sample solution comprises protein crystals.
